(19) United States
(12) Patent Application Publication
(10) Pub. No.: US 2024/0061213 A1
(43) Pub. Date: Feb. 22, 2024

(54) OPTICAL LENS ASSEMBLY AND A PHOTOGRAPHING MODULE

(71) Applicant: NEWMAX TECHNOLOGY CO., LTD., Taichung City (TW)

(72) Inventors: Ching-Yun HUANG, Taichung City (TW); Chi-Chang WANG, Taichung City (TW)

(21) Appl. No.: 17/981,456

(22) Filed: Nov. 6, 2022

(30) Foreign Application Priority Data
Aug. 22, 2022 (TW) 111131430

(51) Int. Cl. G02B 13/00; G02B 9/62; G02B 5/20; G02B 7/02

(52) U.S. Cl. CPC G02B 13/0045; G02B 9/62; G02B 5/208; G02B 7/021

(57) ABSTRACT

An optical lens assembly includes, in order from an object side to an image side: a first lens with negative refractive power; a second lens with negative refractive power; a third lens with positive refractive power; a fourth lens with positive refractive power; a fifth lens with negative refractive power; a sixth lens with positive refractive power; and an IR band-pass filter. A maximum field of view of the optical lens assembly is FOV, a radius of curvature of an object-side surface of the second lens is R3, a radius of curvature of an image-side surface of the third lens is R6, an angle between a chief ray incident on an image plane at a maximum view angle of the optical lens assembly, and a normal line of the image plane is CRA, and the following condition is satisfied: −36.91<FOV*R3/(CRA*R6)<−2.28.

### BACKGROUND

### Field of the Invention

The present invention relates to an optical lens assembly, and more particularly to an optical lens assembly and a photographing module workable in infrared (IR) light band.

### Description of Related Art

With the emergence of the concept of metaverse, the augmented reality (AR) and virtual reality (VR) industries are flourishing in recent years, which brings on the demand for ultra-wide angle lens devices. An appropriate lens device is one of the indispensable elements in AR and VR applications. Nowadays, AR and VR lens devices not only require a large field of view, but also minimize the height of the optical lens assembly.

### SUMMARY

The objective of the present invention is to provide an optical lens assembly and a photographing module. When a specific condition is satisfied, the optical lens assembly can have a compact size and provide a high relative illumination under the premise of a large aperture and ultra-wide field of view.

Therefore, an optical lens assembly in accordance with the present invention includes, in order from an object side to an image side: a first lens with negative refractive power, including an object-side surface and an image-side surface, the object-side surface of the first lens being convex in a paraxial region thereof, and the image-side surface of the first lens being concave in a paraxial region thereof; a second lens with negative refractive power, including an object-side surface and an image-side surface, the object-side surface of the second lens being convex in a paraxial region thereof, and the image-side surface of the second lens being concave in a paraxial region thereof; a third lens with positive refractive power, including an object-side surface and an image-side surface, the object-side surface of the third lens being convex in a paraxial region thereof, and the image-side surface of the third lens being convex in a paraxial region thereof; a fourth lens with positive refractive power, including an object-side surface and an image-side surface, the object-side surface of the fourth lens being convex in a paraxial region thereof, and the image-side surface of the fourth lens being convex in a paraxial region thereof; a fifth lens with negative refractive power, including an object-side surface and an image-side surface, the object-side surface of the fifth lens being concave in a paraxial region thereof, and the image-side surface of the fifth lens being concave in a paraxial region thereof; a sixth lens with positive refractive power, including an object-side surface and an image-side surface, the object-side surface of the sixth lens being convex in a paraxial region thereof, and the image-side surface of the sixth lens being convex in a paraxial region thereof; and an IR band-pass filter, wherein a maximum field of view of the optical lens assembly is FOV, a radius of curvature of the object-side surface of the second lens is R3, a radius of curvature of the image-side surface of the third lens is R6, an angle between a chief ray incident on an image plane at a maximum view angle of the optical lens assembly, and a normal line of the image plane is CRA, and the following condition is satisfied: −36.91<FOV*R3/(CRA*R6)<−2.28, which is favorable to achieving a better design of curvatures of lenses, so as to maintain the wide angle characteristic and provide a better match with an image sensor.

Optionally, the optical lens assembly has a total of six lenses with refractive power.

Optionally, a focal length of the optical lens assembly is f, a focal length of the first lens is f1, and the following condition is satisfied: −0.33<f/f1<−0.18, which is favorable to enhancing the wide angle characteristic of the optical lens assembly, so as to provide a larger field of view.

Optionally, a focal length of the third lens is f3, a central thickness of the third lens along an optical axis is CT3, and the following condition is satisfied: 0.61 mm²<f3*CT3<3.26 mm², which is favorable to achieving a better design of thicknesses of lenses and better distribution of refractive power of the lenses, so as to reduce the tolerance of lens manufacturing.

Optionally, the focal length of the optical lens assembly is f, a focal length of the fourth lens is f4, and the following condition is satisfied: 0.39<f/f4<0.69, which is favorable to achieving more appropriate distribution of refractive power, so as to correct the aberration of the optical lens assembly for the enhancement of the image quality of the optical lens assembly.

Optionally, the focal length of the fourth lens is f4, a focal length of the fifth lens is f5, a central thickness of the fourth lens along the optical axis is CT4, a central thickness of the fifth lens along the optical axis is CT5, and the following condition is satisfied: −0.77<(f4/CT4)/(f5/CT5)<−0.44, which is favorable to providing a better ratio of the thickness to the refractive power of the lens, so as to correct the aberration of the optical lens assembly for the enhancement of the image quality of the optical lens assembly.

Optionally, a distance from the object-side surface of the first lens to the image plane along the optical axis is TL, a maximum image height of the optical lens assembly is IMH, and the following condition is satisfied: 3.47<TL/IMH<6.40, which is favorable to providing a better ratio of the height and the image size of the optical lens assembly, so as to reach the ultra-wide angle and reduce the height of the optical lens assembly.

Optionally, the focal length of the optical lens assembly is f, the distance from the object-side surface of the first lens to the image plane along the optical axis is TL, a distance from the image-side surface of the sixth lens to the image plane along the optical axis is BFL, and the following condition is satisfied: 1.88 mm²<(TL−BFL)*f<4.40 mm², which is favorable to providing an appropriate space for the lenses and an appropriate rear focal space.

Optionally, an Abbe number of the fourth lens is vd4, an Abbe number of the fifth lens is vd5, and the following condition is satisfied: 28.50<vd4−vd5<44.11, which is favorable to providing a better arrangement of the lenses, so as to correct the aberration of the optical lens assembly for the enhancement of the image quality of the optical lens assembly.

Optionally, the focal length of the fifth lens is f5, a refractive index of the fifth lens is nd5, and the following condition is satisfied: −0.80 mm<f5/nd5<−0.49 mm, which is favorable to providing a better choice of lens material and a better distribution of refractive power.

Optionally, a radius of curvature of the object-side surface of the first lens is R1, a radius of curvature of the image-side surface of the first lens is R2, and the following condition is satisfied: 2.73<R1/R2<5.11, which is favorable to achieving a better design of curvatures of lenses, so as to reduce the tolerance of lens manufacturing.

Optionally, the radius of curvature of the object-side surface of the first lens is R1, the radius of curvature of the image-side surface of the first lens is R2, the radius of curvature of the object-side surface of the second lens is R3, and the following condition is satisfied: 0.47 mm<R1*R2/R3<2.11 mm, which is favorable to achieving a better design of curvatures of lenses, so as to satisfy the wide angle characteristic and increase the relative illumination of the optical lens assembly.

Optionally, a focal length of the second lens is f2, the radius of curvature of the object-side surface of the second lens is R3, and the following condition is satisfied: −16.57 mm²<R3*f2<−6.42 mm², which is favorable to correcting the aberration of the optical lens assembly, so as to enhance the image quality of the optical lens assembly.

Optionally, the radius of curvature of the object-side surface of the second lens is R3, the radius of curvature of the image-side surface of the third lens is R6, and the following condition is satisfied: −7.21<R3/R6<−0.43, which is favorable to providing a better design of curvatures of lenses, so as to reduce the sensitivities of the lenses and the assembly tolerance.

Optionally, the focal length of the second lens is f2, the focal length of the third lens is f3, and the following condition is satisfied: −8.13 mm²<f2*f3<−1.43 mm², which is favorable to distributing the refractive power of the optical lens assembly more appropriately, so as to correct the aberration of the optical lens assembly for the enhancement of the image quality of the optical lens assembly.

Optionally, the focal length of the optical lens assembly is f, the radius of curvature of the object-side surface of the second lens is R3, half of the maximum view angle (field of view) of the optical lens assembly is HFOV, and the following condition is satisfied: 3.25°<HFOV*f/R3<13.12°, which is favorable to adjusting the balance between the focal length of the optical lens assembly and the collection of light at a large angle, so as to enhance the image quality of the optical lens assembly.

Optionally, the distance from the image-side surface of the sixth lens to the image plane along the optical axis is BFL, and the following condition is satisfied: 0.62 mm<BFL<1.33 mm.

Optionally, the angle between the chief ray incident on the image plane at the maximum view angle of the optical lens assembly, and the normal line of the image plane is CRA, and the following condition is satisfied: 23.90°<CRA<37.49°.

Optionally, the focal length of the second lens is f2, the focal length of the third lens is f3, and the following condition is satisfied: −1.07<f2/f3<−0.41, which is favorable to distributing the refractive power of the optical lens assembly more appropriately, so as to maintain the wide angle characteristic and increase the relative illumination of the optical lens assembly.

Optionally, the focal length of the third lens is f3, the focal length of the fifth lens is f5, and the following condition is satisfied: −4.26<f3/f5<−1.01, which is favorable to distributing the refractive power of the optical lens assembly more appropriately, so as to correct the aberration of the optical lens assembly for the enhancement of the image quality of the optical lens assembly.

Optionally, the focal length of the fourth lens is f4, a focal length of the sixth lens is f6, and the following condition is satisfied: 0.65<f4/f6<1.12, which is favorable to distributing the refractive power of the optical lens assembly more appropriately, so as to correct the aberration of the optical lens assembly for the enhancement of the image quality of the optical lens assembly.

Optionally, a central thickness of the second lens along the optical axis is CT2, the central thickness of the third lens along the optical axis is CT3, and the following condition is satisfied: 1.22<CT3/CT2<2.35, which is favorable to achieving a better ratio of the thicknesses of the lenses and reducing the problem of lens formability.

Moreover, a photographing module in accordance with the present invention includes a lens barrel, an optical lens assembly disposed in the lens barrel, and an image sensor disposed on an image plane of the optical lens assembly. The optical lens assembly includes, in order from an object side to an image side: a first lens with negative refractive power, including an object-side surface and an image-side surface, the object-side surface of the first lens being convex in a paraxial region thereof, and the image-side surface of the first lens being concave in a paraxial region thereof; a second lens with negative refractive power, including an object-side surface and an image-side surface, the object-side surface of the second lens being convex in a paraxial region thereof, and the image-side surface of the second lens being concave in a paraxial region thereof; a third lens with positive refractive power, including an object-side surface and an image-side surface, the object-side surface of the third lens being convex in a paraxial region thereof, and the image-side surface of the third lens being convex in a paraxial region thereof; a fourth lens with positive refractive power, including an object-side surface and an image-side surface, the object-side surface of the fourth lens being convex in a paraxial region thereof, and the image-side surface of the fourth lens being convex in a paraxial region thereof; a fifth lens with negative refractive power, including an object-side surface and an image-side surface, the object-side surface of the fifth lens being concave in a paraxial region thereof, and the image-side surface of the fifth lens being concave in a paraxial region thereof; a sixth lens with positive refractive power, including an object-side surface and an image-side surface, the object-side surface of the sixth lens being convex in a paraxial region thereof, and the image-side surface of the sixth lens being convex in a paraxial region thereof; and an IR band-pass filter, wherein a maximum field of view of the optical lens assembly is FOV, a radius of curvature of the object-side surface of the second lens is R3, a radius of curvature of the image-side surface of the third lens is R6, an angle between a chief ray incident on the image plane at a maximum view angle of the optical lens assembly, and a normal line of the image plane is CRA, and the following condition is satisfied: −36.91<FOV*R3/(CRA*R6)<−2.28, which is favorable to achieving a better design of curvatures of lenses, so as to maintain the wide angle characteristic and provide a better match with the image sensor.

Optionally, the optical lens assembly has a total of six lenses with refractive power.

Optionally, a focal length of the optical lens assembly is f, a focal length of the first lens is f1, and the following condition is satisfied: −0.33<f/f1<−0.18, which is favorable to enhancing the wide angle characteristic of the optical lens assembly, so as to provide a larger field of view.

Optionally, a focal length of the third lens is f3, a central thickness of the third lens along an optical axis is CT3, and the following condition is satisfied: 0.61 mm²<f3*CT3<3.26 mm², which is favorable to achieving a better design of thicknesses of lenses and better distribution of refractive power of the lenses, so as to reduce the tolerance of lens manufacturing.

Optionally, the focal length of the optical lens assembly is f, a focal length of the fourth lens is f4, and the following condition is satisfied: 0.39<f/f4<0.69, which is favorable to achieving more appropriate distribution of refractive power, so as to correct the aberration of the optical lens assembly for the enhancement of the image quality of the optical lens assembly.

Optionally, the focal length of the fourth lens is f4, a focal length of the fifth lens is f5, a central thickness of the fourth lens along the optical axis is CT4, a central thickness of the fifth lens along the optical axis is CT5, and the following condition is satisfied: −0.77<(f4/CT4)/(f5/CT5)<−0.44, which is favorable to providing a better ratio of the thickness to the refractive power of the lens, so as to correct the aberration of the optical lens assembly for the enhancement of the image quality of the optical lens assembly.

Optionally, a distance from the object-side surface of the first lens to the image plane along the optical axis is TL, a maximum image height of the optical lens assembly is IMH, and the following condition is satisfied: 3.47<TL/IMH<6.40, which is favorable to providing a better ratio of the height and the image size of the optical lens assembly, so as to reach the ultra-wide angle and reduce the height of the optical lens assembly.

Optionally, the focal length of the optical lens assembly is f, the distance from the object-side surface of the first lens to the image plane along the optical axis is TL, a distance from the image-side surface of the sixth lens to the image plane along the optical axis is BFL, and the following condition is satisfied: 1.88 mm²<(TL−BFL)*f<4.40 mm², which is favorable to providing an appropriate space for the lenses and an appropriate rear focal space.

Optionally, an Abbe number of the fourth lens is vd4, an Abbe number of the fifth lens is vd5, and the following condition is satisfied: 28.50<vd4−vd5<44.11, which is favorable to providing a better arrangement of the lenses, so as to correct the aberration of the optical lens assembly for the enhancement of the image quality of the optical lens assembly.

Optionally, the focal length of the fifth lens is f5, a refractive index of the fifth lens is nd5, and the following condition is satisfied: −0.80 mm<f5/nd5<−0.49 mm, which is favorable to providing a better choice of lens material and a better distribution of refractive power.

Optionally, a radius of curvature of the object-side surface of the first lens is R1, a radius of curvature of the image-side surface of the first lens is R2, and the following condition is satisfied: 2.73<R1/R2<5.11, which is favorable to achieving a better design of curvatures of lenses, so as to reduce the tolerance of lens manufacturing.

Optionally, the radius of curvature of the object-side surface of the first lens is R1, the radius of curvature of the image-side surface of the first lens is R2, the radius of curvature of the object-side surface of the second lens is R3, and the following condition is satisfied: 0.47 mm<R1*R2/R3<2.11 mm, which is favorable to achieving a better design of curvatures of lenses, so as to satisfy the wide angle characteristic and increase the relative illumination of the optical lens assembly.

Optionally, a focal length of the second lens is f2, the radius of curvature of the object-side surface of the second lens is R3, and the following condition is satisfied: −16.57 mm²<R3*f2<−6.42 mm², which is favorable to correcting the aberration of the optical lens assembly, so as to enhance the image quality of the optical lens assembly.

Optionally, the radius of curvature of the object-side surface of the second lens is R3, the radius of curvature of the image-side surface of the third lens is R6, and the following condition is satisfied: −7.21<R3/R6<−0.43, which is favorable to providing a better design of curvatures of lenses, so as to reduce the sensitivities of the lenses and the assembly tolerance.

Optionally, the focal length of the second lens is f2, the focal length of the third lens is f3, and the following condition is satisfied: −8.13 mm²<f2*f3<−1.43 mm², which is favorable to distributing the refractive power of the optical lens assembly more appropriately, so as to correct the aberration of the optical lens assembly for the enhancement of the image quality of the optical lens assembly.

Optionally, the focal length of the optical lens assembly is f, the radius of curvature of the object-side surface of the second lens is R3, half of the maximum view angle (field of view) of the optical lens assembly is HFOV, and the following condition is satisfied: 3.25°<HFOV*f/R3<13.12°, which is favorable to adjusting the balance between the focal length of the optical lens assembly and the collection of light at a large angle, so as to enhance the image quality of the optical lens assembly.

Optionally, the distance from the image-side surface of the sixth lens to the image plane along the optical axis is BFL, and the following condition is satisfied: 0.62 mm<BFL<1.33 mm.

Optionally, the angle between the chief ray incident on the image plane at the maximum view angle of the optical lens assembly, and the normal line of the image plane is CRA, and the following condition is satisfied: 23.90°<CRA<37.49°.

Optionally, the focal length of the second lens is f2, the focal length of the third lens is f3, and the following condition is satisfied: −1.07<f2/f3<−0.41, which is favorable to distributing the refractive power of the optical lens assembly more appropriately, so as to maintain the wide angle characteristic and increase the relative illumination of the optical lens assembly.

Optionally, the focal length of the third lens is f3, the focal length of the fifth lens is f5, and the following condition is satisfied: −4.26<f3/f5<−1.01, which is favorable to distributing the refractive power of the optical lens assembly more appropriately, so as to correct the aberration of the optical lens assembly for the enhancement of the image quality of the optical lens assembly.

Optionally, the focal length of the fourth lens is f4, a focal length of the sixth lens is f6, and the following condition is satisfied: 0.65<f4/f6<1.12, which is favorable to distributing the refractive power of the optical lens assembly more appropriately, so as to correct the aberration of the optical lens assembly for the enhancement of the image quality of the optical lens assembly.

Optionally, a central thickness of the second lens along the optical axis is CT2, the central thickness of the third lens along the optical axis is CT3, and the following condition is satisfied: 1.22<CT3/CT2<2.35, which is favorable to achieving a better ratio of the thicknesses of the lenses and reducing the problem of lens formability.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A shows a schematic view of an optical lens assembly in accordance with a first embodiment of the present invention;

FIG. 1B shows, from left to right, the field curvature curve and the distortion curve of the optical lens assembly of the first embodiment of the present invention;

FIG. 1C shows a part of the optical lens assembly with parameters in accordance with the first embodiment of the present invention;

FIG. 2A shows a schematic view of an optical lens assembly in accordance with a second embodiment of the present invention;

FIG. 2B shows, from left to right, the field curvature curve and the distortion curve of the optical lens assembly of the second embodiment of the present invention;

FIG. 3A shows a schematic view of an optical lens assembly in accordance with a third embodiment of the present invention;

FIG. 3B shows, from left to right, the field curvature curve and the distortion curve of the optical lens assembly of the third embodiment of the present invention;

FIG. 4A shows a schematic view of an optical lens assembly in accordance with a fourth embodiment of the present invention;

FIG. 4B shows, from left to right, the field curvature curve and the distortion curve of the optical lens assembly of the fourth embodiment of the present invention;

FIG. 5A shows a schematic view of an optical lens assembly in accordance with a fifth embodiment of the present invention;

FIG. 5B shows, from left to right, the field curvature curve and the distortion curve of the optical lens assembly of the fifth embodiment of the present invention; and

FIG. 6 shows a schematic view of a photographing module in accordance with a sixth embodiment of the present invention.

### DETAILED DESCRIPTION

### First Embodiment

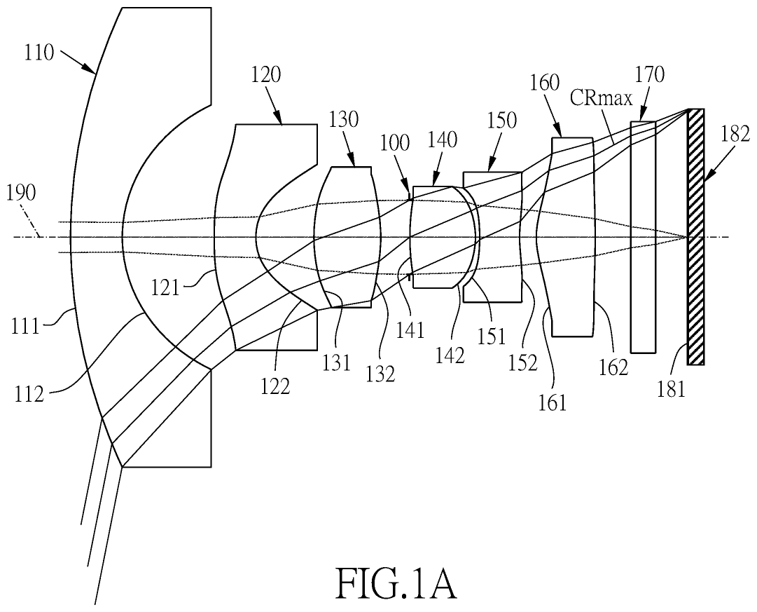

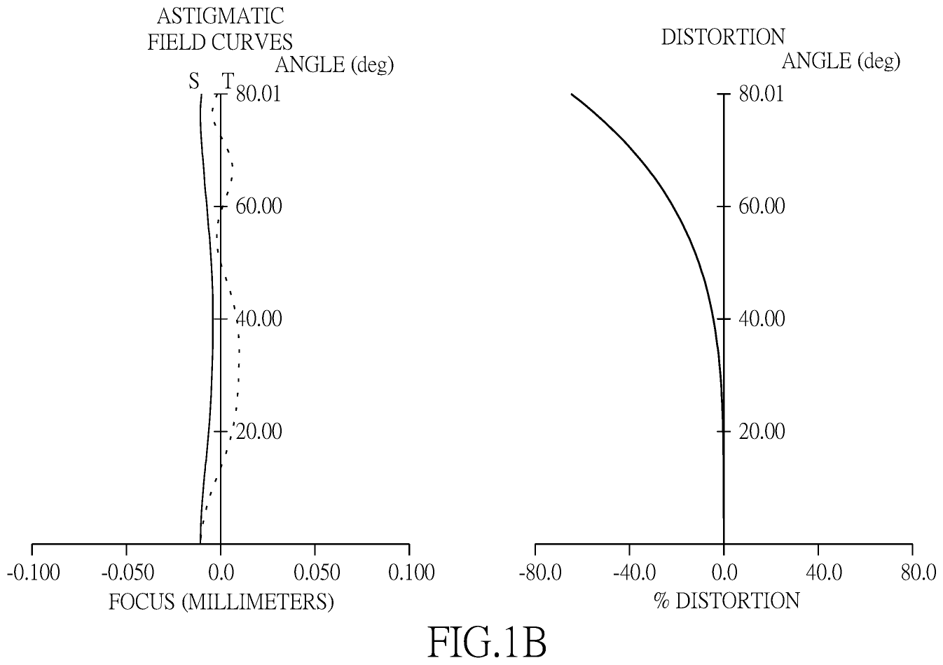

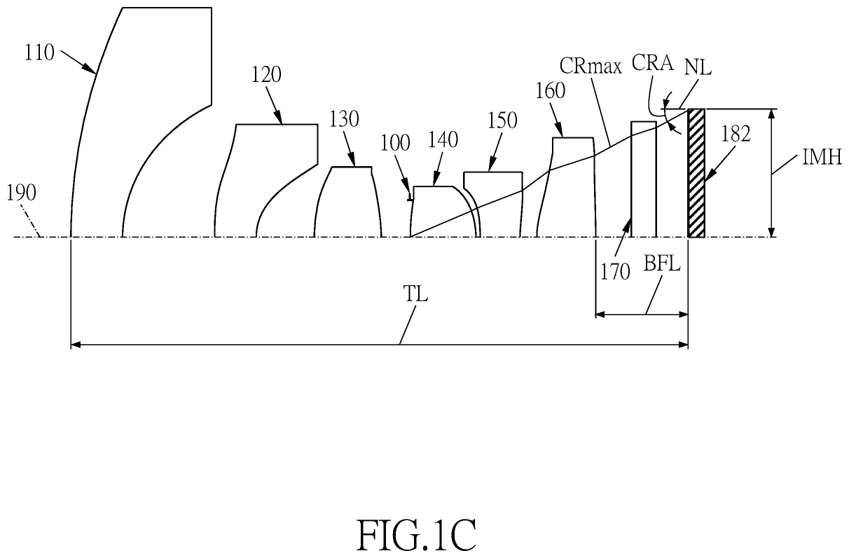

Referring to FIGS. 1A to 1C, an optical lens assembly in accordance with a first embodiment of the present invention includes, in order from an object side to an image side along an optical axis 190: a first lens 110, a second lens 120, a third lens 130, a stop 100, a fourth lens 140, a fifth lens 150, a sixth lens 160, an IR band-pass filter 170, and an image plane 181. The optical lens assembly works in cooperation with an image sensor 182. The image sensor 182 is disposed on the image plane 181. The optical lens assembly has a total of six lenses with refractive power, but not limited thereto.

The first lens 110 with negative refractive power includes an object-side surface 111 and an image-side surface 112, the object-side surface 111 of the first lens 110 is convex in a paraxial region thereof, the image-side surface 112 of the first lens 110 is concave in a paraxial region thereof, the object-side surface 111 and the image-side surface 112 of the first lens 110 are spherical, and the first lens 110 is made of glass.

The second lens 120 with negative refractive power includes an object-side surface 121 and an image-side surface 122, the object-side surface 121 of the second lens 120 is convex in a paraxial region thereof, the image-side surface 122 of the second lens 120 is concave in a paraxial region thereof, the object-side surface 121 and the image-side surface 122 of the second lens 120 are aspheric, and the second lens 120 is made of plastic.

The third lens 130 with positive refractive power includes an object-side surface 131 and an image-side surface 132, the object-side surface 131 of the third lens 130 is convex in a paraxial region thereof, the image-side surface 132 of the third lens 130 is convex in a paraxial region thereof, the object-side surface 131 and the image-side surface 132 of the third lens 130 are aspheric, and the third lens 130 is made of plastic.

The fourth lens 140 with positive refractive power includes an object-side surface 141 and an image-side surface 142, the object-side surface 141 of the fourth lens 140 is convex in a paraxial region thereof, the image-side surface 142 of the fourth lens 140 is convex in a paraxial region thereof, the object-side surface 141 and the image-side surface 142 of the fourth lens 140 are aspheric, and the fourth lens 140 is made of plastic.

The fifth lens 150 with negative refractive power includes an object-side surface 151 and an image-side surface 152, the object-side surface 151 of the fifth lens 150 is concave in a paraxial region thereof, the image-side surface 152 of the fifth lens 150 is concave in a paraxial region thereof, the object-side surface 151 and the image-side surface 152 of the fifth lens 150 are aspheric, and the fifth lens 150 is made of plastic.

The sixth lens 160 with positive refractive power includes an object-side surface 161 and an image-side surface 162, the object-side surface 161 of the sixth lens 160 is convex in a paraxial region thereof, the image-side surface 162 of the sixth lens 160 is convex in a paraxial region thereof, the object-side surface 161 and the image-side surface 162 of the sixth lens 160 are aspheric, and the sixth lens 160 is made of plastic.

The IR band-pass filter 170 is made of glass, is located between the sixth lens 160 and the image plane 181, and has no influence on a focal length of the optical lens assembly.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:
z represents the value of a reference position at a height of h with respect to a vertex of the surface of a lens along the optical axis 190;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 190;
k represents the conic constant; and
Aᵢ represents the ith-order aspheric coefficient.

In the first embodiment of the optical lens assembly, a focal length of the optical lens assembly is f, a f-number of the optical lens assembly is Fno, a maximum field of view of the optical lens assembly is FOV, a central thickness of the second lens 120 along the optical axis 190 is CT2, a central thickness of the third lens 130 along the optical axis 190 is CT3, a central thickness of the fourth lens 140 along the optical axis 190 is CT4, a central thickness of the fifth lens 150 along the optical axis 190 is CT5, a distance from the object-side surface 111 of the first lens 110 to the image plane 181 along the optical axis 190 is TL, a distance from the image-side surface 162 of the sixth lens 160 to the image plane 181 along the optical axis 190 is BFL, a maximum image height of the optical lens assembly is IMH, an angle between a chief ray CRmax incident on the image plane 181 at a maximum view angle of the optical lens assembly, and a normal line NL of the image plane 181 is CRA, and the values of the parameters are shown as follows: f=0.60 mm; Fno=2.06; FOV=160.0°; CT2=0.35 mm; CT3=0.56 mm; CT4=0.56 mm; CT5=0.34 mm; TL=5.20 mm; BFL=0.78 mm; IMH=1.20 mm; and CRA=31.25°.

In the first embodiment of the optical lens assembly, the focal length of the optical lens assembly is f, a focal length of the first lens 110 is f1, and the following condition is satisfied: f/f1=−0.24

In the first embodiment of the optical lens assembly, a focal length of the second lens 120 is f2, a focal length of the third lens 130 is f3, and the following condition is satisfied: f2/f3=−0.89.

In the first embodiment of the optical lens assembly, the focal length of the third lens 130 is f3, a focal length of the fifth lens 150 is f5, and the following condition is satisfied: f3/f5=−1.27.

In the first embodiment of the optical lens assembly, a focal length of the fourth lens 140 is f4, a focal length of the sixth lens 160 is f6, and the following condition is satisfied: f4/f6=0.86.

In the first embodiment of the optical lens assembly, the focal length of the third lens 130 is f3, the central thickness of the third lens 130 along the optical axis 190 is CT3, and the following condition is satisfied: f3*CT3=0.80 mm².

In the first embodiment of the optical lens assembly, the focal length of the optical lens assembly is f, the focal length of the fourth lens 140 is f4, and the following condition is satisfied: f/f4=0.50.

In the first embodiment of the optical lens assembly, the focal length of the fourth lens 140 is f4, the focal length of the fifth lens 150 is f5, the central thickness of the fourth lens 140 along the optical axis 190 is CT4, the central thickness of the fifth lens 150 along the optical axis 190 is CT5, and the following condition is satisfied: (f4/CT4)/(f5/CT5)=−0.64.

In the first embodiment of the optical lens assembly, the distance from the object-side surface 111 of the first lens 110 to the image plane 181 along the optical axis 190 is TL, the maximum image height of the optical lens assembly is IMH, and the following condition is satisfied: TL/IMH=4.33.

In the first embodiment of the optical lens assembly, the focal length of the optical lens assembly is f, the distance from the object-side surface 111 of the first lens 110 to the image plane 181 along the optical axis 190 is TL, the distance from the image-side surface 162 of the sixth lens 160 to the image plane 181 along the optical axis 190 is BFL, and the following condition is satisfied: (TL−BFL)*f=2.64 mm².

In the first embodiment of the optical lens assembly, an Abbe number of the fourth lens 140 is vd4, an Abbe number of the fifth lens 150 is vd5, and the following condition is satisfied: vd4−vd5=36.76.

In the first embodiment of the optical lens assembly, the focal length of the fifth lens 150 is f5, a refractive index of the fifth lens 150 is nd5, and the following condition is satisfied: f5/nd5=−0.67 mm.

In the first embodiment of the optical lens assembly, a radius of curvature of the object-side surface 111 of the first lens 110 is R1, a radius of curvature of the image-side surface 112 of the first lens 110 is R2, and the following condition is satisfied: R1/R2=3.99.

In the first embodiment of the optical lens assembly, the radius of curvature of the object-side surface 111 of the first lens 110 is R1, the radius of curvature of the image-side surface 112 of the first lens 110 is R2, a radius of curvature of the object-side surface 121 of the second lens 120 is R3, and the following condition is satisfied: R1*R2/R3=0.81 mm.

In the first embodiment of the optical lens assembly, the radius of curvature of the object-side surface 121 of the second lens 120 is R3, the focal length of the second lens 120 is f2, and the following condition is satisfied: R3*f2=−12.41 mm².

In the first embodiment of the optical lens assembly, the radius of curvature of the object-side surface 121 of the second lens 120 is R3, a radius of curvature of the image-side surface 132 of the third lens 130 is R6, and the following condition is satisfied: R3/R6=−6.01.

In the first embodiment of the optical lens assembly, the focal length of the second lens 120 is f2, the focal length of the third lens 130 is f3, and the following condition is satisfied: f2*f3=−1.78 mm.

In the first embodiment of the optical lens assembly, half of the maximum field of view of the optical lens assembly is HFOV, the focal length of the optical lens assembly is f, the radius of curvature of the object-side surface 121 of the second lens 120 is R3, and the following condition is satisfied: HFOV*f/R3=4.85°.

In the first embodiment of the optical lens assembly, the central thickness of the second lens 120 along the optical axis 190 is CT2, the central thickness of the third lens 130 along the optical axis 190 is CT3, and the following condition is satisfied: CT3/CT2=1.61.

In the first embodiment of the optical lens assembly, the maximum field of view of the optical lens assembly is FOV, the radius of curvature of the object-side surface 121 of the second lens 120 is R3, the angle between the chief ray CRmax incident on the image plane 181 at the maximum field of view of the optical lens assembly, and the normal line NL of the image plane 181 is CRA, the radius of curvature of the image-side surface 132 of the third lens 130 is R6, and the following condition is satisfied: FOV*R3/(CRA*R6)=−30.76.

The detailed optical data of the respective elements in the optical lens assembly of the first embodiment is shown in Table 1, and the aspheric surface data of the lenses in the first embodiment is shown in Table 2.

TABLE 1
Embodiment 1
f(focal length) = 0.60 mm, Fno = 2.06, FOV = 160.0°

| | | Curvature | | Thickness/ | | Refractive | Abbe | Focal |
|---|---|---|---|---|---|---|---|---|
| Surface | | Radius | | gap | Material | Index (nd) | number (vd) | length |
| 0 | Object | infinity | | infinity | — | — | — | — |
| 1 | First lens | 5.650 | | 0.435 | glass | 1.804 | 46.5 | −2.52 |
| 2 | | 1.417 | | 0.776 | — | — | — | — |
| 3 | Second lens | 9.860 | (ASP) | 0.350 | plastic | 1.544 | 56.0 | −1.26 |
| 4 | | 0.623 | (ASP) | 0.490 | — | — | — | — |
| 5 | Third lens | 1.777 | (ASP) | 0.563 | plastic | 1.671 | 19.2 | 1.42 |
| 6 | | −1.642 | (ASP) | 0.242 | — | — | — | — |
| 7 | Stop | infinity | | 0.003 | — | — | — | — |
| 8 | Fourth lens | 3.090 | (ASP) | 0.555 | plastic | 1.544 | 56.0 | 1.19 |
| 9 | | −0.750 | (ASP) | 0.035 | — | — | — | — |
| 10 | Fifth lens | −1.669 | (ASP) | 0.335 | plastic | 1.671 | 19.2 | −1.12 |
| 11 | | 1.367 | (ASP) | 0.141 | — | — | — | — |
| 12 | Sixth lens | 0.799 | (ASP) | 0.497 | plastic | 1.544 | 56.0 | 1.38 |
| 13 | | −7.432 | (ASP) | 0.300 | — | — | — | — |

| | | | | | | | |
|---|---|---|---|---|---|---|---|
| 14 | IR band-pass filter | infinity | 0.210 | glass | 1.517 | 64.2 | — |
| 15 | | infinity | 0.267 | — | — | — | — |
| 16 | Image plane | infinity | — | — | — | — | — |

Note:
the reference wavelength is 940 nm

TABLE 2
Aspheric Coefficients

| Surface | 1 | 2 | 3 | 4 |
|---|---|---|---|---|
| K: | 0.00E+00 | 0.00E+00 | 2.64E+01 | −5.11E−01 |
| A2: | 0.00E+00 | 0.00E+00 | 0.00E+00 | 0.00E+00 |
| A4: | 0.00E+00 | 0.00E+00 | 1.08E+00 | 1.72E+00 |
| A6: | 0.00E+00 | 0.00E+00 | −3.50E+00 | −3.14E+00 |
| A8: | 0.00E+00 | 0.00E+00 | 8.47E+00 | −2.55E+01 |
| A10: | 0.00E+00 | 0.00E+00 | −1.63E+01 | 2.44E+02 |
| A12: | 0.00E+00 | 0.00E+00 | 2.26E+01 | −1.17E+03 |
| A14: | 0.00E+00 | 0.00E+00 | −2.11E+01 | 3.32E+03 |
| A16: | 0.00E+00 | 0.00E+00 | 1.26E+01 | −5.51E+03 |
| A18: | 0.00E+00 | 0.00E+00 | −4.31E+00 | 4.88E+03 |
| A20: | 0.00E+00 | 0.00E+00 | 6.46E−01 | −1.78E+03 |

| Surface | 5 | 6 | 8 | 9 |
|---|---|---|---|---|
| K: | −1.80E+00 | −1.98E+01 | −9.72E+00 | 1.72E−01 |
| A2: | 0.00E+00 | 0.00E+00 | 0.00E+00 | 0.00E+00 |
| A4: | 2.11E−01 | −5.37E−02 | 5.59E−01 | 1.03E+00 |
| A6: | −1.45E+00 | 1.82E−02 | 1.38E+01 | 2.10E+01 |
| A8: | −1.55E+02 | 1.13E+01 | −5.74E+02 | −6.64E+02 |
| A10: | −1.55E+02 | −1.33E+02 | 1.23E+04 | 7.74E+03 |
| A12: | 7.88E+02 | 8.73E+02 | −1.62E+05 | −5.65E+04 |
| A14: | −2.52E+03 | −3.48E+03 | 1.31E+06 | 2.69E+05 |
| A16: | 4.94E+03 | 7.82E+03 | −6.18E+06 | −7.95E+05 |
| A18: | −5.41E+03 | −9.03E+03 | 1.54E+07 | 1.29E+06 |
| A20: | 2.49E+03 | 4.14E+03 | −1.53E+07 | −8.75E+05 |
| Surface | 10 | 11 | 12 | 13 |
| K: | 7.56E+00 | −6.31E+01 | −1.49E+01 | 5.28E+01 |
| A2: | 0.00E+00 | 0.00E+00 | 0.00E+00 | 0.00E+00 |
| A4: | −1.14E+00 | −1.06E+00 | 3.13E−01 | 1.83E−01 |
| A6: | 5.50E+01 | 7.26E+00 | −5.83E+00 | −1.05E−01 |
| A8: | −1.29E+03 | −4.80E+01 | 3.92E+01 | −2.34E+00 |
| A10: | 1.61E+04 | 2.46E+02 | −1.60E+02 | 1.51E+01 |
| A12: | −1.31E+05 | −1.04E+03 | 4.24E+02 | −4.42E+01 |
| A14: | 6.87E+05 | 3.47E+03 | −7.35E+02 | 7.27E+01 |
| A16: | −2.20E+06 | −7.95E+03 | 8.03E+02 | −7.04E+01 |
| A18: | 3.91E+06 | 1.07E+04 | −5.02E+02 | 3.77E+01 |
| A20: | −2.98E+06 | −6.40E+03 | 1.36E+02 | −8.67E+00 |

In Table 1, the units of the radius of curvature, the thickness, the gap and the focal length are expressed in mm, and the surface numbers 0-16 respectively represent the surfaces sequentially arranged from the object-side to the image-side, wherein the surface 0 represents a gap between an object and the object-side surface 111 of the first lens 110 along the optical axis 190; the surfaces 1, 3, 5, 8, 10, 12 and 14 represent the central thicknesses of the first lens 110, the second lens 120, the third lens 130, the fourth lens 140, the fifth lens 150, the sixth lens 160 and the IR band-pass filter 170 along the optical axis 190, respectively; the surface 2 represents a gap between the image-side surface 112 of the first lens 110 and the object-side surface 121 of the second lens 120 along the optical axis 190; the surface 4 represents a gap between the image-side surface 122 of the second lens 120 and the object-side surface 131 of the third lens 130 along the optical axis 190; the surface 6 represents a gap between the image-side surface 132 of the third lens 130 and the stop 100 along the optical axis 190; the surface 7 represents a gap between the stop 100 and the object-side surface 141 of the fourth lens 140 along the optical axis 190; the surface 9 represents a gap between the image-side surface 142 of the fourth lens 140 and the object-side surface 151 of the fifth lens 150 along the optical axis 190; the surface 11 represents a gap between the image-side surface 152 of the fifth lens 150 and the object-side surface 161 of the sixth lens 160 along the optical axis 190; the surface 13 represents a gap between the image-side surface 162 of the sixth lens 160 and the IR band-pass filter 170 along the optical axis 190; and the surface 15 represents a gap between the IR band-pass filter 170 and the image plane 181 along the optical axis 190.

In table 2, k represents the conic constant of the curve equation of aspheric surface profiles, and A2, A4, A6, A8, A10, A12, A14, A16, A18, and A20 represent the high-order aspheric coefficients.

The respective tables presented below for respective one of other embodiments are based on the schematic view of this embodiment, and the definitions of parameters in the tables are the same as those in the first embodiment. Therefore, an explanation in this regard will not be provided again. Moreover, in each of the embodiments of the present invention, the maximum effective radius of either of surfaces of one lens is usually a vertical distance between an intersection of a ray, passing through the edge of the entrance pupil, in the incident light at a maximum view angle of the optical lens assembly and the surface of the lens and the optical axis, or is a radius of a part of the surface of the lens which is not subjected to any surface treatment (e.g., forming a concave and convex structure, or performing ink coating, etc. on the surface of the lens), or a radius of a light-transmissive part of the lens (as a shield or spacing ring, etc. blocks another part of the lens), but not limited thereto.

### Second Embodiment

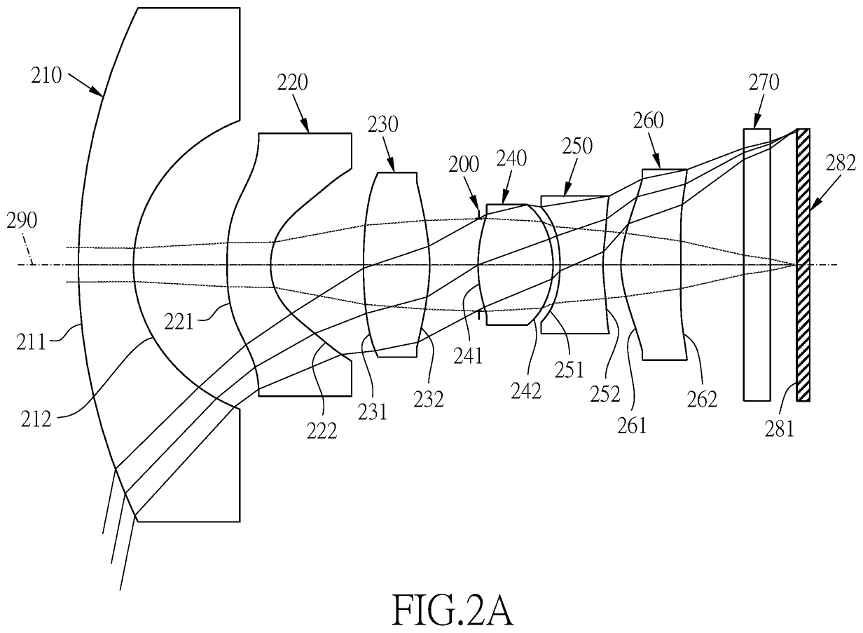

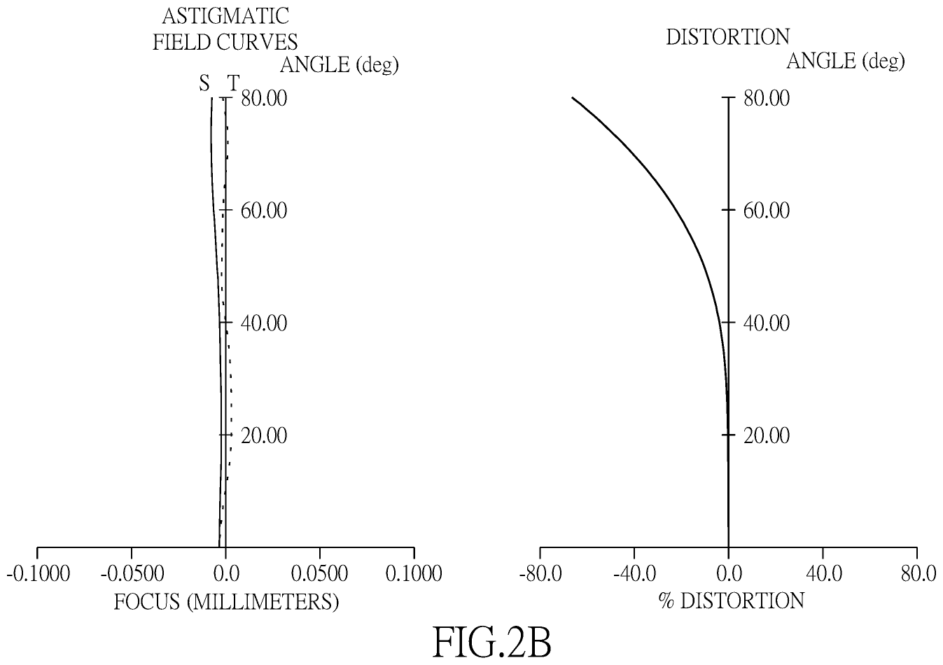

Referring to FIGS. 2A and 2B, an optical lens assembly in accordance with a second embodiment of the present invention includes, in order from an object side to an image side along an optical axis 290: a first lens 210, a second lens 220, a third lens 230, a stop 200, a fourth lens 240, a fifth lens 250, a sixth lens 260, an IR band-pass filter 270, and an image plane 281. The optical lens assembly works in cooperation with an image sensor 282. The image sensor 282 is disposed on the image plane 281. The optical lens assembly has a total of six lenses with refractive power, but not limited thereto.

The first lens 210 with negative refractive power includes an object-side surface 211 and an image-side surface 212, the object-side surface 211 of the first lens 210 is convex in a paraxial region thereof, the image-side surface 212 of the first lens 210 is concave in a paraxial region thereof, the object-side surface 211 and the image-side surface 212 of the first lens 210 are spherical, and the first lens 210 is made of glass.

The second lens 220 with negative refractive power includes an object-side surface 221 and an image-side surface 222, the object-side surface 221 of the second lens 220 is convex in a paraxial region thereof, the image-side surface 222 of the second lens 220 is concave in a paraxial region thereof, the object-side surface 221 and the image-side surface 222 of the second lens 220 are aspheric, and the second lens 220 is made of plastic.

The third lens 230 with positive refractive power includes an object-side surface 231 and an image-side surface 232, the object-side surface 231 of the third lens 230 is convex in a paraxial region thereof, the image-side surface 232 of the third lens 230 is convex in a paraxial region thereof, the object-side surface 231 and the image-side surface 232 of the third lens 230 are aspheric, and the third lens 230 is made of plastic.

The fourth lens 240 with positive refractive power includes an object-side surface 241 and an image-side surface 242, the object-side surface 241 of the fourth lens 240 is convex in a paraxial region thereof, the image-side surface 242 of the fourth lens 240 is convex in a paraxial region thereof, the object-side surface 241 and the image-side surface 242 of the fourth lens 240 are aspheric, and the fourth lens 240 is made of plastic.

The fifth lens 250 with negative refractive power includes an object-side surface 251 and an image-side surface 252, the object-side surface 251 of the fifth lens 250 is concave in a paraxial region thereof, the image-side surface 252 of the fifth lens 250 is concave in a paraxial region thereof, the object-side surface 251 and the image-side surface 252 of the fifth lens 250 are aspheric, and the fifth lens 250 is made of plastic.

The sixth lens 260 with positive refractive power includes an object-side surface 261 and an image-side surface 262, the object-side surface 261 of the sixth lens 260 is convex in a paraxial region thereof, the image-side surface 262 of the sixth lens 260 is convex in a paraxial region thereof, the object-side surface 261 and the image-side surface 262 of the sixth lens 260 are aspheric, and the sixth lens 260 is made of plastic.

The IR band-pass filter 270 is made of glass, is located between the sixth lens 260 and the image plane 281, and has no influence on the focal length of the optical lens assembly.

The detailed optical data of the respective elements in the optical lens assembly of the second embodiment is shown in Table 3, the aspheric surface data of the lenses in the second embodiment is shown in Table 4, and various parameters of the optical lens assembly and various conditions are shown in Table 5.

TABLE 3
Embodiment 2
f(focal length) = 0.63 mm, Fno = 2.05, FOV = 160.0°

| | | Curvature | | Thickness/ | | Refractive | Abbe | Focal |
|---|---|---|---|---|---|---|---|---|
| Surface | | Radius | | gap | Material | Index (nd) | number (vd) | length |
| 0 | Object | infinity | | infinity | — | — | — | — |
| 1 | First lens | 5.795 | | 0.435 | glass | 1.804 | 46.5 | −2.45 |
| 2 | | 1.400 | | 0.744 | — | — | — | — |
| 3 | Second lens | 4.609 | (ASP) | 0.345 | plastic | 1.544 | 56.0 | −1.74 |
| 4 | | 0.755 | (ASP) | 0.737 | — | — | — | — |
| 5 | Third lens | 5.087 | (ASP) | 0.525 | plastic | 1.671 | 19.2 | 2.24 |
| 6 | | −1.933 | (ASP) | 0.392 | — | — | — | — |
| 7 | Stop | infinity | | −0.006 | — | — | — | — |
| 8 | Fourth lens | 1.545 | (ASP) | 0.596 | plastic | 1.544 | 56.0 | 1.17 |
| 9 | | −0.912 | (ASP) | 0.054 | — | — | — | — |
| 10 | Fifth lens | −1.574 | (ASP) | 0.342 | plastic | 1.661 | 20.4 | −1.07 |
| 11 | | 1.295 | (ASP) | 0.141 | — | — | — | — |
| 12 | Sixth lens | 0.824 | (ASP) | 0.477 | plastic | 1.544 | 56.0 | 1.44 |
| 13 | | −10.228 | (ASP) | 0.500 | — | — | — | — |

| | | | | | | | |
|---|---|---|---|---|---|---|---|
| 14 | IR band-pass filter | infinity | 0.210 | glass | 1.517 | 64.2 | — |
| 15 | | infinity | 0.208 | — | — | — | — |
| 16 | Image plane | infinity | — | — | — | — | — |

Note:
the reference wavelength is 940 nm

TABLE 4
Aspheric Coefficients

| Surface | 1 | 2 | 3 | 4 |
|---|---|---|---|---|
| K: | 0.00E+00 | 0.00E+00 | 1.26E+01 | −4.61E−01 |
| A2: | 0.00E+00 | 0.00E+00 | 0.00E+00 | 0.00E+00 |
| A4: | 0.00E+00 | 0.00E+00 | 9.91E−01 | 1.63E+00 |
| A6: | 0.00E+00 | 0.00E+00 | −2.65E+00 | −3.43E+00 |
| A8: | 0.00E+00 | 0.00E+00 | 5.77E+00 | 1.51E+00 |
| A10: | 0.00E+00 | 0.00E+00 | −1.03E+01 | 2.89E+01 |
| A12: | 0.00E+00 | 0.00E+00 | 1.21E+01 | −2.51E+02 |
| A14: | 0.00E+00 | 0.00E+00 | −8.55E+00 | 8.64E+02 |
| A16: | 0.00E+00 | 0.00E+00 | 3.50E+00 | −1.49E+03 |
| A18: | 0.00E+00 | 0.00E+00 | −7.26E−01 | 1.30E+03 |
| A20: | 0.00E+00 | 0.00E+00 | 5.09E−02 | −4.56E+02 |

| Surface | 5 | 6 | 8 | 9 |
|---|---|---|---|---|
| K: | −8.40E+00 | −1.94E+01 | −5.59E+00 | 2.59E−02 |
| A2: | 0.00E+00 | 0.00E+00 | 0.00E+00 | 0.00E+00 |
| A4: | 1.72E−01 | −1.09E−01 | 3.83E−01 | −5.51E−01 |
| A6: | −4.48E−01 | 7.11E−01 | 3.75E+00 | 2.04E+01 |
| A8: | −1.38E+01 | −5.70E+00 | −1.24E+02 | −3.03E+02 |
| A10: | −1.38E+01 | 3.49E+01 | 1.99E+03 | 2.44E+03 |
| A12: | 4.95E+01 | −1.32E+02 | −2.01E+04 | −1.30E+04 |
| A14: | −1.08E+02 | 3.03E+02 | 1.26E+05 | 4.57E+04 |
| A16: | 1.45E+02 | −3.93E+02 | −4.78E+05 | −1.02E+05 |
| A18: | −1.06E+02 | 2.48E+02 | 9.91E+05 | 1.28E+05 |
| A20: | 2.99E+01 | −5.04E+01 | −8.58E+05 | −6.88E+04 |
| Surface | 10 | 11 | 12 | 13 |
| K: | 4.60E+00 | −4.12E+01 | −1.12E+01 | 9.83E+01 |
| A2: | 0.00E+00 | 0.00E+00 | 0.00E+00 | 0.00E+00 |
| A4: | −1.97E+00 | −1.09E+00 | 1.67E−01 | 3.80E−01 |
| A6: | 3.56E+01 | 9.03E+00 | −1.10E+00 | 1.03E−01 |
| A8: | −4.81E+02 | −6.35E+01 | 5.79E+00 | −3.01E+00 |
| A10: | 4.17E+03 | 3.60E+02 | −2.12E+01 | 1.26E+01 |
| A12: | −2.52E+04 | −1.53E+03 | 4.50E+01 | −3.41E+01 |
| A14: | 1.03E+05 | 4.61E+03 | −4.91E+01 | 6.03E+01 |
| A16: | −2.67E+05 | −9.08E+03 | 9.00E+00 | −6.63E+01 |
| A18: | 3.96E+05 | 1.04E+04 | 3.35E+01 | 4.14E+01 |
| A20: | −2.55E+05 | −5.20E+03 | −2.36E+01 | −1.12E+01 |

TABLE 5
Embodiment 2

| | | | | | |
|---|---|---|---|---|---|
| TL [mm] | 5.70 | f3*CT3 [mm²] | 1.18 | R1*R2/R3 [mm] | 1.76 |
| BFL [mm] | 0.92 | f/f4 | 0.54 | R3*f2 [mm²] | −8.02 |
| IMH [mm] | 1.20 | (f4/CT4)/ | −0.63 | R3/R6 | −2.38 |
| | | (f5/CT5) | | | |
| CRA [°] | 31.23 | TL/IMH | 4.75 | f2*f3 [mm²] | −3.90 |
| f/f1 | −0.26 | (TL-BFL)*f | 3.01 | HFOV*f/R3 [°] | 10.93 |
| | | [mm²] | | | |
| f2/f3 | −0.78 | vd4-vd5 | 35.63 | CT3/CT2 | 1.52 |
| f3/f5 | −2.10 | f5/nd5 [mm] | −0.64 | FOV*R3/ | −12.22 |
| | | | | (CRA*R6) | |
| f4/f6 | 0.81 | R1/R2 | 4.14 | — | — |

In the second embodiment, the curve equation of the aspheric surface profiles of the aforementioned lenses is the same as the curve equation of the aspheric surface profiles of the aforementioned lenses in the first embodiment. The values of the parameters in Table 5 can be calculated from Tables 3 and 4, and the conditions in Table 5 are satisfied.

### Third Embodiment

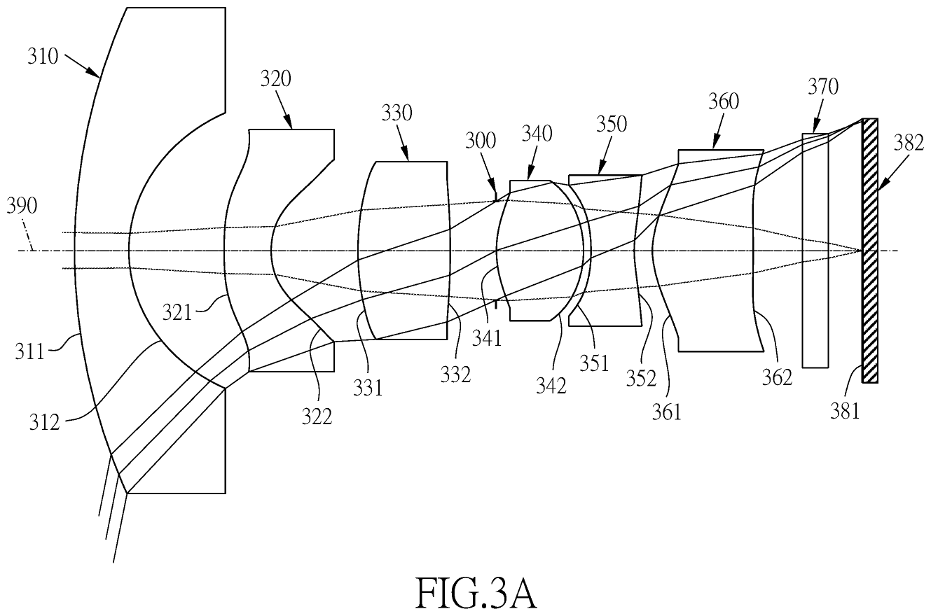

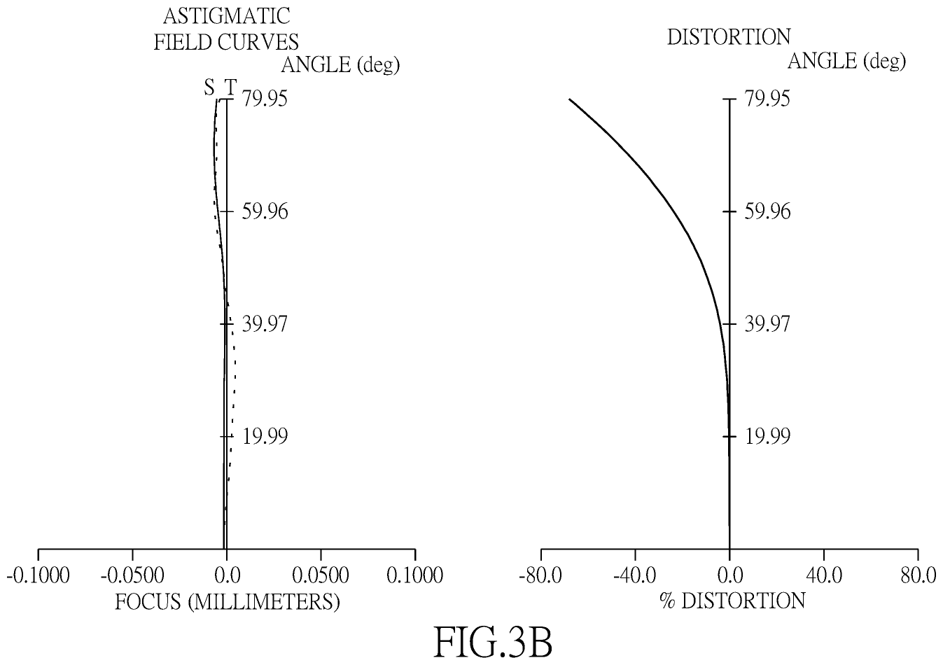

Referring to FIGS. 3A and 3B, an optical lens assembly in accordance with a third embodiment of the present invention includes, in order from an object side to an image side along an optical axis 390: a first lens 310, a second lens 320, a third lens 330, a stop 300, a fourth lens 340, a fifth lens 350, a sixth lens 360, an IR band-pass filter 370, and an image plane 381. The optical lens assembly works in cooperation with an image sensor 382. The image sensor 382 is disposed on the image plane 381. The optical lens assembly has a total of six lenses with refractive power, but not limited thereto.

The first lens 310 with negative refractive power includes an object-side surface 311 and an image-side surface 312, the object-side surface 311 of the first lens 310 is convex in a paraxial region thereof, the image-side surface 312 of the first lens 310 is concave in a paraxial region thereof, the object-side surface 311 and the image-side surface 312 of the first lens 310 are spherical, and the first lens 310 is made of glass.

The second lens 320 with negative refractive power includes an object-side surface 321 and an image-side surface 322, the object-side surface 321 of the second lens 320 is convex in a paraxial region thereof, the image-side surface 322 of the second lens 320 is concave in a paraxial region thereof, the object-side surface 321 and the image-side surface 322 of the second lens 320 are aspheric, and the second lens 320 is made of plastic.

The third lens 330 with positive refractive power includes an object-side surface 331 and an image-side surface 332, the object-side surface 331 of the third lens 330 is convex in a paraxial region thereof, the image-side surface 332 of the third lens 330 is convex in a paraxial region thereof, the object-side surface 331 and the image-side surface 332 of the third lens 330 are aspheric, and the third lens 330 is made of plastic.

The fourth lens 340 with positive refractive power includes an object-side surface 341 and an image-side surface 342, the object-side surface 341 of the fourth lens 340 is convex in a paraxial region thereof, the image-side surface 342 of the fourth lens 340 is convex in a paraxial region thereof, the object-side surface 341 and the image-side surface 342 of the fourth lens 340 are aspheric, and the fourth lens 340 is made of plastic.

The fifth lens 350 with negative refractive power includes an object-side surface 351 and an image-side surface 352, the object-side surface 351 of the fifth lens 350 is concave in a paraxial region thereof, the image-side surface 352 of the fifth lens 350 is concave in a paraxial region thereof, the object-side surface 351 and the image-side surface 352 of the fifth lens 350 are aspheric, and the fifth lens 350 is made of plastic.

The sixth lens 360 with positive refractive power includes an object-side surface 361 and an image-side surface 362, the object-side surface 361 of the sixth lens 360 is convex in a paraxial region thereof, the image-side surface 362 of the sixth lens 360 is convex in a paraxial region thereof, the object-side surface 361 and the image-side surface 362 of the sixth lens 360 are aspheric, and the sixth lens 360 is made of plastic.

The IR band-pass filter 370 is made of glass, is located between the sixth lens 360 and the image plane 381, and has no influence on the focal length of the optical lens assembly.

The detailed optical data of the respective elements in the optical lens assembly of the second embodiment is shown in Table 6, the aspheric surface data of the lenses in the second embodiment is shown in Table 7, and various parameters of the optical lens assembly and various conditions are shown in Table 8.

TABLE 6
Embodiment 3
f(focal length) = 0.67 mm, Fno = 2.04, FOV = 159.9°

| | | Curvature | | Thickness/ | | Refractive | Abbe | Focal |
|---|---|---|---|---|---|---|---|---|
| Surface | | Radius | | gap | Material | Index (nd) | number (vd) | length |
| 0 | Object | infinity | | infinity | — | — | — | — |
| 1 | First lens | 5.976 | | 0.442 | glass | 1.804 | 46.5 | −2.43 |
| 2 | | 1.402 | | 0.775 | — | — | — | — |
| 3 | Second lens | 5.459 | (ASP) | 0.381 | plastic | 1.544 | 56.0 | −1.87 |
| 4 | | 0.825 | (ASP) | 0.707 | — | — | — | — |
| 5 | Third lens | 2.937 | (ASP) | 0.748 | plastic | 1.671 | 19.2 | 3.63 |
| 6 | | −10.261 | (ASP) | 0.374 | — | — | — | — |
| 7 | Stop | infinity | | 0.003 | — | — | — | — |
| 8 | Fourth lens | 1.111 | (ASP) | 0.707 | plastic | 1.544 | 56.0 | 1.16 |
| 9 | | −1.101 | (ASP) | 0.062 | — | — | — | — |
| 10 | Fifth lens | −1.904 | (ASP) | 0.350 | plastic | 1.661 | 20.4 | −1.02 |
| 11 | | 1.054 | (ASP) | 0.147 | — | — | — | — |
| 12 | Sixth lens | 0.733 | (ASP) | 0.821 | plastic | 1.544 | 56.0 | 1.29 |
| 13 | | −7.783 | (ASP) | 0.400 | — | — | — | — |

| | | | | | | | |
|---|---|---|---|---|---|---|---|
| 14 | IR band-pass filter | infinity | 0.210 | glass | 1.517 | 64.2 | — |
| 15 | | infinity | 0.274 | — | — | — | — |
| 16 | Image plane | infinity | — | — | — | — | — |

Note:
the reference wavelength is 940 nm

TABLE 7
Aspheric Coefficients

| Surface | 1 | 2 | 3 | 4 |
|---|---|---|---|---|
| K: | 0.00E+00 | 0.00E+00 | 1.29E+01 | −5.00E−01 |
| A2: | 0.00E+00 | 0.00E+00 | 0.00E+00 | 0.00E+00 |
| A4: | 0.00E+00 | 0.00E+00 | 8.62E−01 | 1.40E+00 |
| A6: | 0.00E+00 | 0.00E+00 | −2.12E+00 | −2.81E+00 |
| A8: | 0.00E+00 | 0.00E+00 | 4.36E+00 | 1.49E+00 |
| A10: | 0.00E+00 | 0.00E+00 | −7.52E+00 | 1.47E+01 |
| A12: | 0.00E+00 | 0.00E+00 | 8.58E+00 | −1.35E+02 |
| A14: | 0.00E+00 | 0.00E+00 | −6.35E+00 | 4.42E+02 |
| A16: | 0.00E+00 | 0.00E+00 | 3.06E+00 | −7.01E+02 |
| A18: | 0.00E+00 | 0.00E+00 | −8.88E−01 | 5.53E+02 |
| A20: | 0.00E+00 | 0.00E+00 | 1.18E−01 | −1.74E+02 |

| Surface | 5 | 6 | 8 | 9 |
|---|---|---|---|---|
| K: | −1.23E+01 | 3.93E+00 | −5.62E+00 | −3.40E−01 |
| A2: | 0.00E+00 | 0.00E+00 | 0.00E+00 | 0.00E+00 |
| A4: | 1.87E−01 | −6.81E−02 | 3.19E−01 | −1.37E+00 |
| A6: | −5.22E−01 | −3.22E−01 | 6.59E−02 | 2.43E+01 |
| A8: | −1.20E+01 | 7.37E+00 | −1.51E+01 | −2.60E+02 |
| A10: | −1.20E+01 | −7.56E+01 | 1.54E+02 | 1.70E+03 |
| A12: | 3.48E+01 | 4.57E+02 | −8.03E+02 | −7.37E+03 |
| A14: | −6.92E+01 | −1.66E+03 | 1.70E+03 | 2.10E+04 |
| A16: | 9.77E+01 | 3.57E+03 | 1.53E+03 | −3.75E+04 |
| A18: | −8.11E+01 | −4.19E+03 | −1.32E+04 | 3.78E+04 |
| A20: | 2.80E+01 | 2.05E+03 | 1.62E+04 | −1.63E+04 |
| Surface | 10 | 11 | 12 | 13 |
| K: | 4.57E+00 | −3.06E+01 | −8.83E+00 | 2.85E+01 |
| A2: | 0.00E+00 | 0.00E+00 | 0.00E+00 | 0.00E+00 |
| A4: | −2.78E+00 | −9.45E−01 | 1.07E−01 | 2.81E−01 |
| A6: | 4.13E+01 | 8.00E+00 | 6.79E−03 | 7.15E−02 |
| A8: | −4.23E+02 | −4.51E+01 | −1.03E−01 | −2.00E−01 |
| A10: | 2.88E+03 | 1.72E+02 | 3.02E−01 | −1.77E−01 |
| A12: | −1.34E+04 | −4.48E+02 | −1.08E+01 | −1.13E−02 |
| A14: | 4.11E+04 | 7.69E+02 | 5.12E+01 | 1.51E+00 |
| A16: | −7.89E+04 | −7.95E+02 | −1.09E+02 | −3.32E+00 |
| A18: | 8.49E+04 | 4.27E+02 | 1.13E+02 | 3.18E+00 |
| A20: | −3.87E+04 | −8.33E+01 | −4.64E+01 | −1.16E+00 |

TABLE 8
Embodiment 3

| | | | | | |
|---|---|---|---|---|---|
| TL [mm] | 6.40 | f3*CT3 [mm²] | 2.71 | R1*R2/R3 [mm] | 1.54 |
| BFL [mm] | 0.88 | f/f4 | 0.57 | R3*f2 [mm²] | −10.20 |
| IMH [mm] | 1.20 | (f4/CT4)/(f5/CT5) | −0.56 | R3/R6 | −0.53 |
| CRA [°] | 29.87 | TL/IMH | 5.33 | f2*f3 [mm²] | −6.78 |
| f/f1 | −0.27 | (TL-BFL)*f[mm²] | 3.67 | HFOV*f/R3 [°] | 9.75 |
| f2/f3 | −0.51 | vd4-vd5 | 35.63 | CT3/CT2 | 1.96 |
| f3/f5 | −3.55 | f5/nd5 [mm] | −0.61 | FOV*R3/(CRA*R6) | −2.85 |
| f4/f6 | 0.90 | R1/R2 | 4.26 | — | — |

In the third embodiment, the curve equation of the aspheric surface profiles of the aforementioned lenses is the same as the curve equation of the aspheric surface profiles of the aforementioned lenses in the first embodiment. The values of the parameters in Table 8 can be calculated from Tables 6 and 7, and the conditions in Table 8 are satisfied.

### Fourth Embodiment

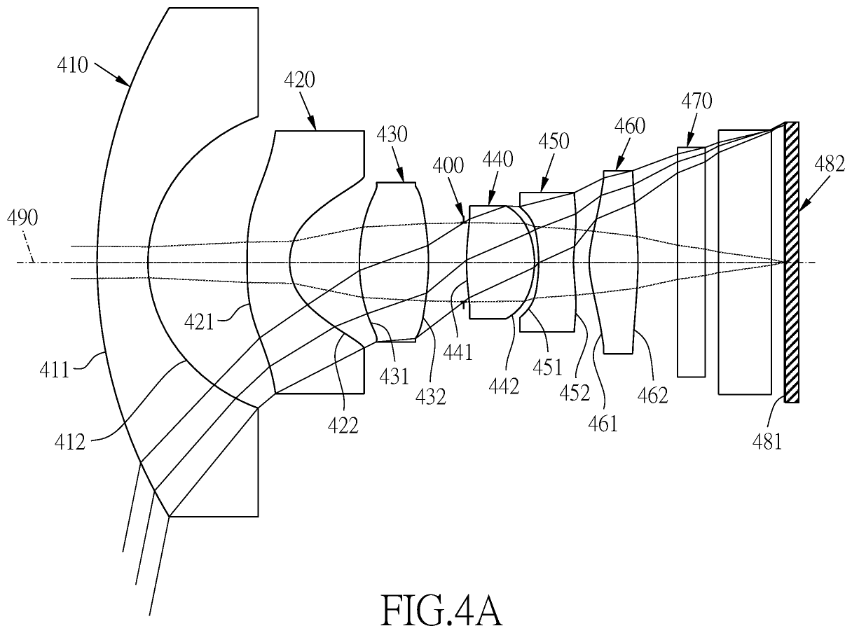

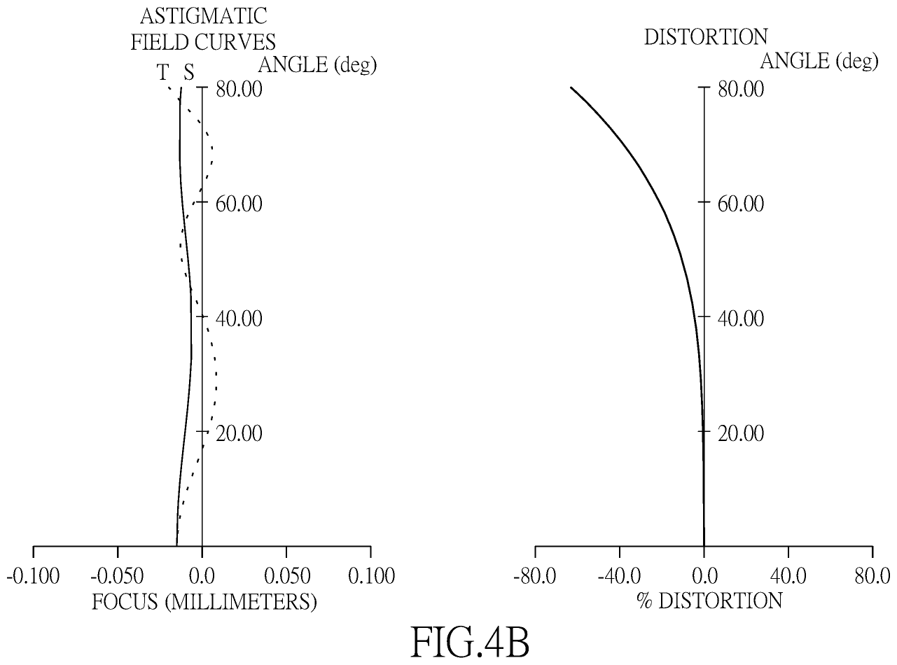

Referring to FIGS. 4A and 4B, an optical lens assembly in accordance with a fourth embodiment of the present invention includes, in order from an object side to an image side along an optical axis 490: a first lens 410, a second lens 420, a third lens 430, a stop 400, a fourth lens 440, a fifth lens 450, a sixth lens 460, an IR band-pass filter 470, a glass element 483, and an image plane 481. The optical lens assembly works in cooperation with an image sensor 482. The image sensor 482 is disposed on the image plane 481. The optical lens assembly has a total of six lenses with refractive power, but not limited thereto.

The first lens 410 with negative refractive power includes an object-side surface 411 and an image-side surface 412, the object-side surface 411 of the first lens 410 is convex in a paraxial region thereof, the image-side surface 412 of the first lens 410 is concave in a paraxial region thereof, the object-side surface 411 and the image-side surface 412 of the first lens 410 are spherical, and the first lens 410 is made of glass.

The second lens 420 with negative refractive power includes an object-side surface 421 and an image-side surface 422, the object-side surface 421 of the second lens 420 is convex in a paraxial region thereof, the image-side surface 422 of the second lens 420 is concave in a paraxial region thereof, the object-side surface 421 and the image-side surface 422 of the second lens 420 are aspheric, and the second lens 420 is made of plastic.

The third lens 430 with positive refractive power includes an object-side surface 431 and an image-side surface 432, the object-side surface 431 of the third lens 430 is convex in a paraxial region thereof, the image-side surface 432 of the third lens 430 is convex in a paraxial region thereof, the object-side surface 431 and the image-side surface 432 of the third lens 430 are aspheric, and the third lens 430 is made of plastic.

The fourth lens 440 with positive refractive power includes an object-side surface 441 and an image-side surface 442, the object-side surface 441 of the fourth lens 440 is convex in a paraxial region thereof, the image-side surface 442 of the fourth lens 440 is convex in a paraxial region thereof, the object-side surface 441 and the image-side surface 442 of the fourth lens 440 are aspheric, and the fourth lens 440 is made of plastic.

The fifth lens 450 with negative refractive power includes an object-side surface 451 and an image-side surface 452, the object-side surface 451 of the fifth lens 450 is concave in a paraxial region thereof, the image-side surface 452 of the fifth lens 450 is concave in a paraxial region thereof, the object-side surface 451 and the image-side surface 452 of the fifth lens 450 are aspheric, and the fifth lens 450 is made of plastic.

The sixth lens 460 with positive refractive power includes an object-side surface 461 and an image-side surface 462, the object-side surface 461 of the sixth lens 460 is convex in a paraxial region thereof, the image-side surface 462 of the sixth lens 460 is convex in a paraxial region thereof, the object-side surface 461 and the image-side surface 462 of the sixth lens 460 are aspheric, and the sixth lens 460 is made of plastic.

The IR band-pass filter 470 is made of glass, is located between the sixth lens 460 and the image plane 481, and has no influence on the focal length of the optical lens assembly.

The glass element 483 is disposed between the IR band-pass filter 470 and the image plane 481 and has no influence on the focal length of the optical lens assembly. The glass element 483 can protect the image sensor 482.

The detailed optical data of the respective elements in the optical lens assembly of the second embodiment is shown in Table 9, the aspheric surface data of the lenses in the second embodiment is shown in Table 10, and various parameters of the optical lens assembly and various conditions are shown in Table 11.

TABLE 9
Embodiment 4
f(focal length) = 0.58 mm, Fno = 2.08, FOV = 160.0°

| | | Curvature | | Thickness/ | | Refractive | Abbe | Focal |
|---|---|---|---|---|---|---|---|---|
| Surface | | Radius | | gap | Material | Index (nd) | number (vd) | length |
| 0 | Object | infinity | | infinity | — | — | — | — |
| 1 | First lens | 4.634 | | 0.385 | glass | 1.804 | 46.5 | −2.57 |
| 2 | | 1.357 | | 0.751 | — | — | — | — |
| 3 | Second lens | 10.649 | (ASP) | 0.321 | plastic | 1.544 | 56.0 | −1.24 |
| 4 | | 0.616 | (ASP) | 0.527 | — | — | — | — |
| 5 | Third lens | 1.761 | (ASP) | 0.522 | plastic | 1.671 | 19.2 | 1.60 |
| 6 | | −2.197 | (ASP) | 0.267 | — | — | — | — |
| 7 | Stop | infinity | | 0.021 | — | — | — | — |
| 8 | Fourth lens | 2.678 | (ASP) | 0.514 | plastic | 1.544 | 56.0 | 1.15 |
| 9 | | −0.745 | (ASP) | 0.031 | — | — | — | — |
| 10 | Fifth lens | −1.662 | (ASP) | 0.265 | plastic | 1.671 | 19.2 | −1.07 |
| 11 | | 1.247 | (ASP) | 0.118 | — | — | — | — |
| 12 | Sixth lens | 0.774 | (ASP) | 0.367 | plastic | 1.544 | 56.0 | 1.23 |
| 13 | | −3.698 | (ASP) | 0.300 | — | — | — | — |

| | | | | | | | |
|---|---|---|---|---|---|---|---|
| 14 | IR band-pass filter | infinity | 0.210 | glass | 1.517 | 64.2 | — |
| 15 | | infinity | 0.100 | — | — | — | — |
| 16 | Glass element | infinity | 0.400 | glass | 1.517 | 64.2 | — |
| 17 | | infinity | 0.274 | — | — | — | — |
| 18 | Image plane | infinity | — | — | — | — | — |

Note:
the reference wavelength is 940 nm

TABLE 10
Aspheric Coefficients

| Surface | 1 | 2 | 3 | 4 |
|---|---|---|---|---|
| K: | 0.00E+00 | 0.00E+00 | 6.49E+01 | −5.27E−01 |
| A2: | 0.00E+00 | 0.00E+00 | 0.00E+00 | 0.00E+00 |
| A4: | 0.00E+00 | 0.00E+00 | 1.19E+00 | 1.87E+00 |
| A6: | 0.00E+00 | 0.00E+00 | −3.78E+00 | −3.41E+00 |
| A8: | 0.00E+00 | 0.00E+00 | 8.98E+00 | −1.90E+01 |
| A10: | 0.00E+00 | 0.00E+00 | −1.70E+01 | 1.75E+02 |
| A12: | 0.00E+00 | 0.00E+00 | 2.29E+01 | −8.32E+02 |
| A14: | 0.00E+00 | 0.00E+00 | −2.06E+01 | 2.35E+03 |
| A16: | 0.00E+00 | 0.00E+00 | 1.17E+01 | −3.72E+03 |
| A18: | 0.00E+00 | 0.00E+00 | −3.78E+00 | 2.93E+03 |
| A20: | 0.00E+00 | 0.00E+00 | 5.31E−01 | −8.56E+02 |

| Surface | 5 | 6 | 8 | 9 |
|---|---|---|---|---|
| K: | −3.29E+00 | −1.95E+01 | −8.03E+01 | 3.33E−01 |
| A2: | 0.00E+00 | 0.00E+00 | 0.00E+00 | 0.00E+00 |
| A4: | 1.92E−01 | 4.46E−02 | 4.15E−01 | 8.08E−01 |
| A6: | −3.04E−01 | 7.47E−02 | 2.89E+01 | 4.08E+01 |
| A8: | 5.29E+00 | 3.09E−01 | −1.27E+03 | −1.08E+03 |
| A10: | −5.29E+01 | −1.54E+01 | 2.93E+04 | 1.22E+04 |
| A12: | 3.23E+02 | 2.11E+02 | −4.13E+05 | −8.54E+04 |
| A14: | −1.20E+03 | −1.36E+03 | 3.58E+06 | 3.87E+05 |
| A16: | 2.67E+03 | 4.11E+03 | −1.83E+07 | −1.08E+06 |
| A18: | −3.35E+03 | −5.89E+03 | 5.00E+07 | 1.68E+06 |
| A20: | 1.74E+03 | 3.28E+03 | −5.43E+07 | −1.08E+06 |
| Surface | 10 | 11 | 12 | 13 |
| K: | 4.27E+00 | −7.71E+01 | −1.78E+01 | 5.37E+00 |
| A2: | 0.00E+00 | 0.00E+00 | 0.00E+00 | 0.00E+00 |
| A4: | −1.98E+00 | −1.43E+00 | 1.84E−02 | 1.21E−01 |
| A6: | 8.96E+01 | 1.23E+01 | −2.65E+00 | 7.83E−01 |
| A8: | −1.92E+03 | −7.93E+01 | 2.23E+01 | −6.82E+00 |
| A10: | 2.28E+04 | 2.89E+02 | −1.02E+02 | 3.33E+01 |
| A12: | −1.76E+05 | −5.23E+02 | 2.82E+02 | −9.95E+01 |
| A14: | 8.77E+05 | 2.87E+01 | −4.82E+02 | 1.82E+02 |
| A16: | −2.69E+06 | 2.00E+03 | 4.99E+02 | −2.01E+02 |
| A18: | 4.60E+06 | −3.79E+03 | −2.85E+02 | 1.23E+02 |
| A20: | −3.34E+06 | 2.37E+03 | 6.76E+01 | −3.22E+01 |

TABLE 11
Embodiment 4

| | | | | | |
|---|---|---|---|---|---|
| TL [mm] | 5.20 | f3*CT3 [mm²] | 0.84 | R1*R2/R3 [mm] | 0.59 |
| BFL [mm] | 1.11 | f/f4 | 0.50 | R3*f2 [mm²] | −13.15 |
| IMH [mm] | 1.20 | (f4/CT4)/ | −0.56 | R3/R6 | −4.85 |
| | | (f5/CT5) | | | |
| CRA [°] | 30.62 | TL/IMH | 4.33 | f2*f3 [mm²] | −1.98 |
| f/f1 | −0.22 | (TL-BFL)*f | 2.35 | HFOV*f/R3 [°] | 4.32 |
| | | [mm²] | | | |
| f2/f3 | −0.77 | vd4-vd5 | 36.76 | CT3/CT2 | 1.63 |
| f3/f5 | −1.50 | f5/nd5 [mm] | −0.64 | FOV*R3/ | −25.32 |
| | | | | (CRA*R6) | |
| f4/f6 | 0.93 | R1/R2 | 3.41 | — | — |

In the fourth embodiment, the curve equation of the aspheric surface profiles of the aforementioned lenses is the same as the curve equation of the aspheric surface profiles of the aforementioned lenses in the first embodiment. The values of the parameters in Table 11 can be calculated from Tables 9 and 10, and the conditions in Table 11 are satisfied. In Table 9, the surface represents a gap between the IR band-pass filter 470 and the glass element 483 along the optical axis 490, the surface 16 represents the central thickness of the glass element 483 along the optical axis 490, and the surface 17 represents a gap between the glass element 483 and the image plane 481 along the optical axis 490.

### Fifth Embodiment

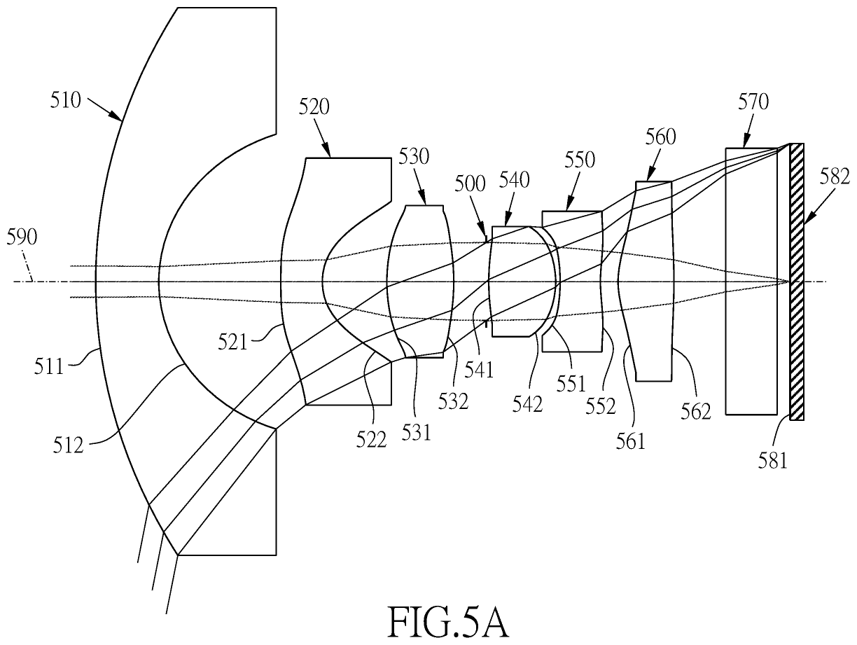

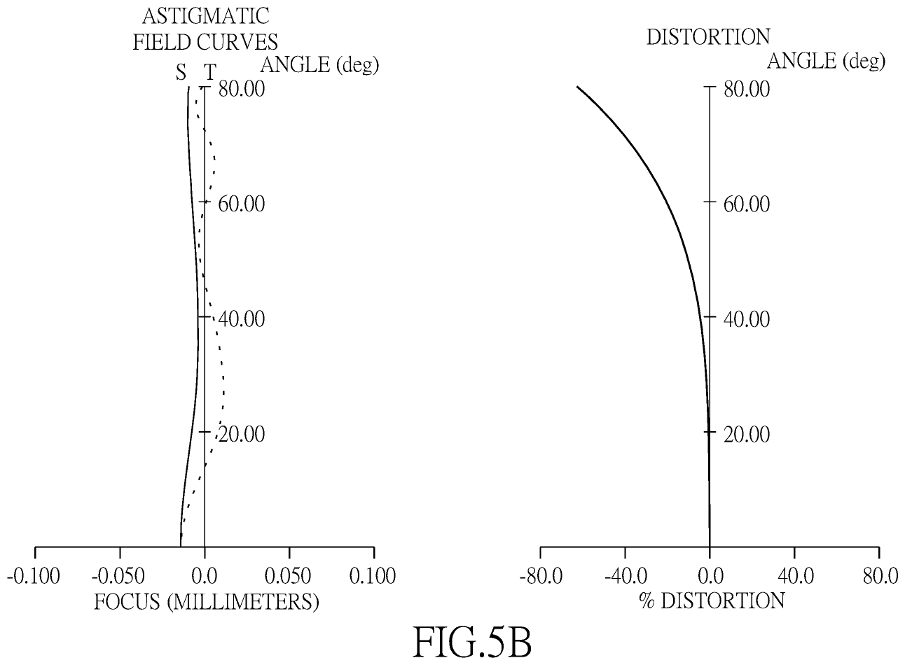

Referring to FIGS. 5A and 5B, an optical lens assembly in accordance with a fifth embodiment of the present invention includes, in order from an object side to an image side along an optical axis 590: a first lens 510, a second lens 520, a third lens 530, a stop 500, a fourth lens 540, a fifth lens 550, a sixth lens 560, an IR band-pass filter 570, and an image plane 581. The optical lens assembly works in cooperation with an image sensor 582. The image sensor 582 is disposed on the image plane 581. The optical lens assembly has a total of six lenses with refractive power, but not limited thereto.

The first lens 510 with negative refractive power includes an object-side surface 511 and an image-side surface 512, the object-side surface 511 of the first lens 510 is convex in a paraxial region thereof, the image-side surface 512 of the first lens 510 is concave in a paraxial region thereof, the object-side surface 511 and the image-side surface 512 of the first lens 510 are spherical, and the first lens 510 is made of glass.

The second lens 520 with negative refractive power includes an object-side surface 521 and an image-side surface 522, the object-side surface 521 of the second lens 520 is convex in a paraxial region thereof, the image-side surface 522 of the second lens 520 is concave in a paraxial region thereof, the object-side surface 521 and the image-side surface 522 of the second lens 520 are aspheric, and the second lens 520 is made of plastic.

The third lens 530 with positive refractive power includes an object-side surface 531 and an image-side surface 532, the object-side surface 531 of the third lens 530 is convex in a paraxial region thereof, the image-side surface 532 of the third lens 530 is convex in a paraxial region thereof, the object-side surface 531 and the image-side surface 532 of the third lens 530 are aspheric, and the third lens 530 is made of plastic.

The fourth lens 540 with positive refractive power includes an object-side surface 541 and an image-side surface 542, the object-side surface 541 of the fourth lens 540 is convex in a paraxial region thereof, the image-side surface 542 of the fourth lens 540 is convex in a paraxial region thereof, the object-side surface 541 and the image-side surface 542 of the fourth lens 540 are aspheric, and the fourth lens 540 is made of plastic.

The fifth lens 550 with negative refractive power includes an object-side surface 551 and an image-side surface 552, the object-side surface 551 of the fifth lens 550 is concave in a paraxial region thereof, the image-side surface 552 of the fifth lens 550 is concave in a paraxial region thereof, the object-side surface 551 and the image-side surface 552 of the fifth lens 550 are aspheric, and the fifth lens 550 is made of plastic.

The sixth lens 560 with positive refractive power includes an object-side surface 561 and an image-side surface 562, the object-side surface 561 of the sixth lens 560 is convex in a paraxial region thereof, the image-side surface 562 of the sixth lens 560 is convex in a paraxial region thereof, the object-side surface 561 and the image-side surface 562 of the sixth lens 560 are aspheric, and the sixth lens 560 is made of plastic.

The IR band-pass filter 570 is made of glass, is located between the sixth lens 560 and the image plane 581, and has no influence on the focal length of the optical lens assembly.

The detailed optical data of the respective elements in the optical lens assembly of the second embodiment is shown in Table 12, the aspheric surface data of the lenses in the second embodiment is shown in Table 13, and various parameters of the optical lens assembly and various conditions are shown in Table 14.

TABLE 12
Embodiment 5
f(focal length) = 0.57 mm, Fno = 2.06, FOV = 160.0°

| | | Curvature | | Thickness/ | | Refractive | Abbe | Focal |
|---|---|---|---|---|---|---|---|---|
| Surface | | Radius | | gap | Material | Index (nd) | number (vd)\| | length |
| 0 | Object | infinity | | infinity | — | — | — | — |
| 1 | First lens | 4.786 | | 0.488 | glass | 1.804 | 46.5 | −2.58 |
| 2 | | 1.361 | | 0.946 | — | — | — | — |
| 3 | Second lens | 11.158 | (ASP) | 0.321 | plastic | 1.544 | 56.0 | −1.24 |
| 4 | | 0.620 | (ASP) | 0.500 | — | — | — | — |
| 5 | Third lens | 1.646 | (ASP) | 0.518 | plastic | 1.671 | 19.2 | 1.47 |
| 6 | | −1.958 | (ASP) | 0.252 | — | — | — | — |
| 7 | Stop | infinity | | 0.021 | - | — | — | — |
| 8 | Fourth lens | 2.988 | (ASP) | 0.518 | plastic | 1.544 | 56.0 | 1.16 |
| 9 | | −0.739 | (ASP) | 0.035 | — | — | — | — |
| 10 | Fifth lens | −1.750 | (ASP) | 0.311 | plastic | 1.671 | 19.2 | -1.11 |
| 11 | | 1.282 | (ASP) | 0.136 | — | — | — | — |
| 12 | Sixth lens | 0.761 | (ASP) | 0.434 | plastic | 1.544 | 56.0 | 1.29 |
| 13 | | −6.265 | (ASP) | 0.400 | — | — | — | — |

| | | | | | | | |
|---|---|---|---|---|---|---|---|
| 14 | IR band-pass filter | infinity | 0.400 | glass | 1.517 | 64.2 | — |
| 15 | | infinity | 0.101 | — | — | — | — |
| 16 | Image plane | infinity | — | — | — | — | — |

Note:
the reference wavelength is 940 nm

TABLE 13
Aspheric Coefficients

| Surface | 1 | 2 | 3 | 4 |
|---|---|---|---|---|
| K: | 0.00E+00 | 0.00E+00 | 6.01E+01 | −5.14E−01 |
| A2: | 0.00E+00 | 0.00E+00 | 0.00E+00 | 0.00E+00 |
| A4: | 0.00E+00 | 0.00E+00 | 1.20E+00 | 1.90E+00 |
| A6: | 0.00E+00 | 0.00E+00 | −3.94E+00 | −3.92E+00 |
| A8: | 0.00E+00 | 0.00E+00 | 9.60E+00 | −1.68E+01 |
| A10: | 0.00E+00 | 0.00E+00 | −1.87E+01 | 1.62E+02 |
| A12: | 0.00E+00 | 0.00E+00 | 2.63E+01 | −7.64E+02 |
| A14: | 0.00E+00 | 0.00E+00 | −2.46E+01 | 2.13E+03 |
| A16: | 0.00E+00 | 0.00E+00 | 1.46E+01 | −3.27E+03 |
| A18: | 0.00E+00 | 0.00E+00 | −4.96E+00 | 2.37E+03 |
| A20: | 0.00E+00 | 0.00E+00 | 7.35E−01 | −5.57E+02 |

| Surface | 5 | 6 | 8 | 9 |
|---|---|---|---|---|
| K: | −2.22E+00 | −2.04E+01 | −5.44E+01 | 2.48E−01 |
| A2: | 0.00E+00 | 0.00E+00 | 0.00E+00 | 0.00E+00 |
| A4: | 1.74E−01 | 4.52E−02 | 4.12E−01 | 8.27E−01 |
| A6: | 2.13E−01 | −9.32E−01 | 2.85E+01 | 3.65E+01 |
| A8: | −3.22E+00 | 1.99E+01 | −1.42E+03 | −1.02E+03 |
| A10: | 2.21E+01 | −2.16E+02 | 3.86E+04 | 1.23E+04 |
| A12: | −7.21E+01 | 1.47E+03 | −6.50E+05 | −9.43E+04 |
| A14: | 1.02E+02 | −6.22E+03 | 6.80E+06 | 4.69E+05 |
| A16: | 7.78E+01 | 1.53E+04 | −4.30E+07 | −1.44E+06 |
| A18: | −4.62E+02 | −1.99E+04 | 1.49E+08 | 2.42E+06 |
| A20: | 3.37E+02 | 1.07E+04 | −2.20E+08 | −1.68E+06 |
| Surface | 10 | 11 | 12 | 13 |
| K: | 7.43E+00 | −6.26E+01 | −1.44E+01 | 3.90E+01 |
| A2: | 0.00E+00 | 0.00E+00 | 0.00E+00 | 0.00E+00 |
| A4: | −1.62E+00 | −1.27E+00 | 1.39E−01 | 1.11E−01 |
| A6: | 7.65E+01 | 8.88E+00 | −4.26E+00 | 4.96E−01 |
| A8: | −1.73E+03 | −3.75E+01 | 3.19E+01 | −5.00E+00 |
| A10: | 2.16E+04 | −4.72E+01 | −1.37E+02 | 2.48E+01 |
| A12: | −1.75E+05 | 1.37E+03 | 3.73E+02 | −6.97E+01 |
| A14: | 9.09E+05 | −7.20E+03 | −6.50E+02 | 1.18E+02 |
| A16: | −2.88E+06 | 1.93E+04 | 7.09E+02 | −1.20E+02 |
| A18: | 5.02E+06 | −2.71E+04 | −4.39E+02 | 6.81E+01 |
| A20: | −3.66E+06 | 1.58E+04 | 1.18E+02 | −1.66E+01 |

TABLE 14
Embodiment 5

| | | | | | |
|---|---|---|---|---|---|
| TL [mm] | 5.38 | f3*CT3 [mm²] | 0.76 | R1*R2/R3 [mm] | 0.58 |
| BFL [mm] | 0.90 | f/f4 | 0.49 | R3*f2 [mm²] | −13.81 |
| IMH [mm] | 1.20 | (f4/CT4)/ | −0.63 | R3/R6 | −5.70 |
| | | (f5/CT5) | | | |
| CRA [°] | 31.20 | TL/IMH | 4.48 | f2*f3 [mm²] | −1.82 |
| f/f1 | −0.22 | (TL-BFL)*f | 2.53 | HFOV*f/R3 [°] | 4.06 |
| | | [mm²] | | | |
| f2/f3 | −0.84 | vd4-vd5 | 36.76 | CT3/CT2 | 1.61 |
| f3/f5 | −1.33 | f5/nd5 [mm] | −0.66 | FOV*R3/ | −29.23 |
| | | | | (CRA*R6) | |
| f4/f6 | 0.90 | R1/R2 | 3.52 | — | — |

In the fifth embodiment, the curve equation of the aspheric surface profiles of the aforementioned lenses is the same as the curve equation of the aspheric surface profiles of the aforementioned lenses in the first embodiment. The values of the parameters in Table 14 can be calculated from Tables 12 and 13, and the conditions in Table 14 are satisfied.

### Sixth Embodiment

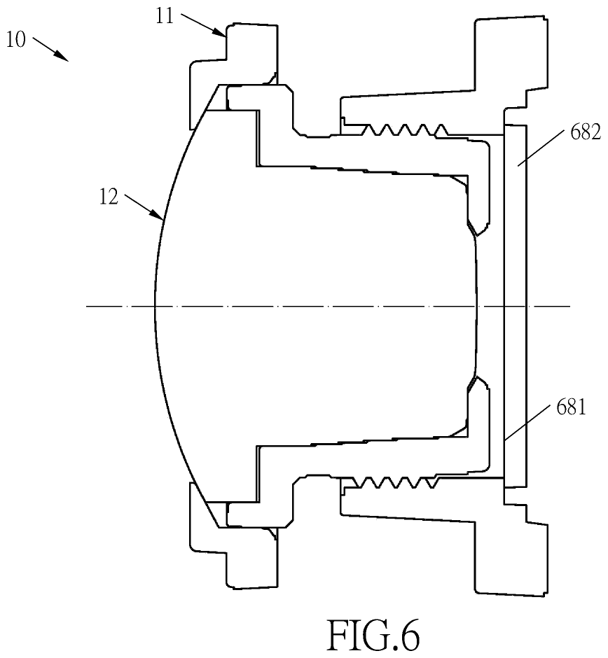

Referring to FIG. 6, a photographing module 10 in accordance with an embodiment of the present invention can be disposed to an electronic device. The photographing module 10 includes a lens barrel 11, an optical lens assembly 12 and an image sensor 682.

The optical lens assembly 12 is the optical lens assembly of any one of the first to fifth embodiments, but not limited thereto. The optical lens assembly 12 is disposed in the lens barrel 11. The image sensor 682 is disposed on an image plane 681 of the optical lens assembly 12 and is an electronic sensor (such as, CMOS, CCD) with good photosensitivity and low noise to really present the imaging quality of the optical lens assembly 12.

For the optical lens assembly in the present invention, the lenses can be made of plastic or glass. If any one of the lenses is made of plastic, it is conducive to reducing the manufacturing cost. If any one of the lenses is made of glass, it is conducive to enhancing the degree of freedom in the arrangement of refractive power of the optical lens assembly. Moreover, both of the object-side and image-side surfaces of the lenses of the optical lens assembly can be aspheric, and the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

In the optical lens assembly of the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

The optical lens assembly of the present invention can be used in focusing optical systems and can obtain better image quality. The optical lens assembly of the present invention can also be used in electronic imaging systems, such as, 3D image capturing device, wearable display of virtual reality (VR) or augmented reality (AR), game player, surveillance camera, digital camera, mobile device, tablet computer or vehicle camera.

What is claimed is:

1. An optical lens assembly, in order from an object side to an image side, comprising:
a first lens with negative refractive power, comprising an object-side surface and an image-side surface, the object-side surface of the first lens being convex in a paraxial region thereof, and the image-side surface of the first lens being concave in a paraxial region thereof;
a second lens with negative refractive power, comprising an object-side surface and an image-side surface, the object-side surface of the second lens being convex in a paraxial region thereof, and the image-side surface of the second lens being concave in a paraxial region thereof;
a third lens with positive refractive power, comprising an object-side surface and an image-side surface, the object-side surface of the third lens being convex in a paraxial region thereof, and the image-side surface of the third lens being convex in a paraxial region thereof;
a fourth lens with positive refractive power, comprising an object-side surface and an image-side surface, the object-side surface of the fourth lens being convex in a paraxial region thereof, and the image-side surface of the fourth lens being convex in a paraxial region thereof;
a fifth lens with negative refractive power, comprising an object-side surface and an image-side surface, the object-side surface of the fifth lens being concave in a paraxial region thereof, and the image-side surface of the fifth lens being concave in a paraxial region thereof;
a sixth lens with positive refractive power, comprising an object-side surface and an image-side surface, the object-side surface of the sixth lens being convex in a paraxial region thereof, and the image-side surface of the sixth lens being convex in a paraxial region thereof; and
an IR band-pass filter;
wherein a maximum field of view of the optical lens assembly is FOV, a radius of curvature of the object-side surface of the second lens is R3, a radius of curvature of the image-side surface of the third lens is R6, an angle between a chief ray incident on an image plane at a maximum view angle of the optical lens assembly, and a normal line of the image plane is CRA, and the following condition is satisfied: −36.91<FOV*R3/(CRA*R6)<−2.28.

2. The optical lens assembly as claimed in claim 1, wherein a focal length of the optical lens assembly is f, a focal length of the first lens is f1, and the following condition is satisfied: −0.33<f/f1<−0.18.

3. The optical lens assembly as claimed in claim 1, wherein a focal length of the third lens is f3, a central thickness of the third lens along an optical axis is CT3, and the following condition is satisfied: 0.61 mm²<f3*CT3<3.26 mm².

4. The optical lens assembly as claimed in claim 1, wherein a focal length of the optical lens assembly is f, a focal length of the fourth lens is f4, and the following condition is satisfied: 0.39<f/f4<0.69.

5. The optical lens assembly as claimed in claim 1, wherein a focal length of the fourth lens is f4, a focal length of the fifth lens is f5, a central thickness of the fourth lens along an optical axis is CT4, a central thickness of the fifth lens along the optical axis is CT5, and the following condition is satisfied: −0.77<(f4/CT4)/(f5/CT5)<−0.44.

6. The optical lens assembly as claimed in claim 1, wherein a distance from the object-side surface of the first lens to the image plane along an optical axis is TL, a maximum image height of the optical lens assembly is IMH, and the following condition is satisfied: 3.47<TL/IMH<6.40.

7. The optical lens assembly as claimed in claim 1, wherein a focal length of the optical lens assembly is f, a distance from the object-side surface of the first lens to the image plane along an optical axis is TL, a distance from the image-side surface of the sixth lens to the image plane along the optical axis is BFL, and the following condition is satisfied: 1.88 mm²<(TL−BFL)*f<4.40 mm².

8. The optical lens assembly as claimed in claim 1, wherein an Abbe number of the fourth lens is vd4, an Abbe number of the fifth lens is vd5, and the following condition is satisfied: 28.50<vd4−vd5<44.11.

9. The optical lens assembly as claimed in claim 1, wherein a focal length of the fifth lens is f5, a refractive index of the fifth lens is nd5, and the following condition is satisfied: −0.80 mm<f5/nd5<−0.49 mm.

10. The optical lens assembly as claimed in claim 1, wherein a radius of curvature of the object-side surface of the first lens is R1, a radius of curvature of the image-side surface of the first lens is R2, and the following condition is satisfied: 2.73<R1/R2<5.11.

11. The optical lens assembly as claimed in claim 1, wherein a radius of curvature of the object-side surface of the first lens is R1, a radius of curvature of the image-side surface of the first lens is R2, the radius of curvature of the object-side surface of the second lens is R3, and the following condition is satisfied: 0.47 mm<R1*R2/R3<2.11 mm.

12. The optical lens assembly as claimed in claim 1, wherein a focal length of the second lens is f2, the radius of curvature of the object-side surface of the second lens is R3, and the following condition is satisfied: −16.57 mm²<R3*f2<−6.42 mm².

13. The optical lens assembly as claimed in claim 1, wherein the radius of curvature of the object-side surface of the second lens is R3, the radius of curvature of the image-side surface of the third lens is R6, and the following condition is satisfied: −7.21<R3/R6<−0.43

14. The optical lens assembly as claimed in claim 1, wherein a focal length of the second lens is f2, a focal length of the third lens is f3, and the following condition is satisfied: −8.13 mm²<f2*f3<−1.43 mm².

15. The optical lens assembly as claimed in claim 1, wherein a focal length of the optical lens assembly is f, the radius of curvature of the object-side surface of the second lens is R3, half of the maximum field of view of the optical lens assembly is HFOV, and the following condition is satisfied: 3.25°<HFOV*f/R3<13.12°.

16. A photographing module, comprising:
a lens barrel;
an optical lens assembly disposed in the lens barrel; and
an image sensor disposed on an image plane of the optical lens assembly,
wherein the optical lens assembly, in order from an object side to an image side, comprising:
a first lens with negative refractive power, comprising an object-side surface and an image-side surface, the object-side surface of the first lens being convex in a paraxial region thereof, and the image-side surface of the first lens being concave in a paraxial region thereof;
a second lens with negative refractive power, comprising an object-side surface and an image-side surface, the object-side surface of the second lens being convex in a paraxial region thereof, and the image-side surface of the second lens being concave in a paraxial region thereof;
a third lens with positive refractive power, comprising an object-side surface and an image-side surface, the object-side surface of the third lens being convex in a paraxial region thereof, and the image-side surface of the third lens being convex in a paraxial region thereof;
a fourth lens with positive refractive power, comprising an object-side surface and an image-side surface, the object-side surface of the fourth lens being convex in a paraxial region thereof, and the image-side surface of the fourth lens being convex in a paraxial region thereof;
a fifth lens with negative refractive power, comprising an object-side surface and an image-side surface, the object-side surface of the fifth lens being concave in a paraxial region thereof, and the image-side surface of the fifth lens being concave in a paraxial region thereof; and
a sixth lens with positive refractive power, comprising an object-side surface and an image-side surface, the object-side surface of the sixth lens being convex in a paraxial region thereof, and the image-side surface of the sixth lens being convex in a paraxial region thereof; and
an IR band-pass filter; and
wherein a maximum field of view of the optical lens assembly is FOV, a radius of curvature of the object-side surface of the second lens is R3, a radius of curvature of the image-side surface of the third lens is R6, an angle between a chief ray incident on an image plane at a the maximum view angle of the optical lens assembly, and a normal line of the image plane is CRA, and the following condition is satisfied: −36.91<FOV*R3/(CRA*R6)<−2.28.

17. The photographing module as claimed in claim 16, wherein a focal length of the optical lens assembly is f, a focal length of the first lens is f1, and the following condition is satisfied: −0.33<f/f1<−0.18.

18. The photographing module as claimed in claim 16, wherein a focal length of the fourth lens is f4, a focal length of the fifth lens is f5, a central thickness of the fourth lens along an optical axis is CT4, a central thickness of the fifth lens along the optical axis is CT5, and the following condition is satisfied: −0.77<(f4/CT4)/(f5/CT5)<−0.44.

19. The photographing module as claimed in claim 16, wherein a focal length of the optical lens assembly is f, a distance from the object-side surface of the first lens to the image plane along an optical axis is TL, a distance from the image-side surface of the sixth lens to the image plane along the optical axis is BFL, and the following condition is satisfied: 1.88 mm²<(TL−BFL)*f<4.40 mm².

20. The photographing module as claimed in claim 16, wherein a focal length of the second lens is f2, the radius of curvature of the object-side surface of the second lens is R3, and the following condition is satisfied: −16.57 mm²<R3*f2<−6.42 mm².
